(19) United States
(12) Patent Application Publication
(10) Pub. No.: US 2005/0232212 A1
(43) Pub. Date: Oct. 20, 2005

(54) Method for handover in a BWA communication system

(75) Inventors: Hyun-Jeong Kang, Seoul (KR); Sung-Jin Lee, Suwon-si (KR); Joon Yoo, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/109,125

(22) Filed: Apr. 19, 2005

(30) Foreign Application Priority Data
Apr. 19, 2004 (KR) 2004-26775

(51) Int. Cl. H04B 1/66

(52) U.S. Cl. 370/338

(57) ABSTRACT

A method for handover in a BWA communication system including MSSs, a serving Base Station, neighbor BSs different from the serving BS, and sponsor nodes. The method includes the steps of: transmitting by the MSS a handover request to the serving BS when the MSS detects a need to handover; selecting by the serving BS a target sponsor node to which the MSS will perform handover, notifying the MSS that the MSS must perform the handover to the target sponsor node; and notifying the serving BS that the MSS will perform the handover to the target sponsor node when the MSS has received a notification from the serving BS that the MSS must perform the handover to the target sponsor node in response to the handover request.

### PRIORITY

This application claims priority to an application entitled “Method for Handover in BWA Communication System” filed in the Korean Intellectual Property Office on Apr. 19, 2004 and assigned Serial No. 2004-26775, the contents of which are hereby incorporated by reference.

### BACKGROUND OF THE INVENTION

1. Field of the Invention

The present invention relates generally to a Broadband Wireless Access (BWA) communication system, and more particularly to a handover method in a mesh mode, in which mesh communication is performed.

2. Description of the Related Art

In a 4^{th} generation (4G) communication system, which is the next generation communication system, research has been actively pursued to provide users with services having various qualities of service (QoS) at a transmission speed of about 10 Mbps. In particular, in the current 4G communication system, research has been actively pursued to support a high speed service capable of ensuring mobility and QoS in a BWA communication system such as a wireless local area network (LAN) system and a wireless metropolitan area network (MAN) system. Representative communication systems of a 4G communication system are an IEEE (Institute of Electrical and Electronics Engineers) 802.16a communication system and an IEEE 802.16e communication system.

The IEEE 802.16a communication system and the IEEE 802.16e communication system utilize an Orthogonal Frequency Division Multiplexing (OFDM) scheme/an Orthogonal Frequency Division Multiple Access (OFDMA) scheme in order to support a broadband transmission network for a physical channel of the wireless MAN system. However, the IEEE 802.16a communication system considers only a single cell structure and stationary Subscriber Stations (SSs), which means the system does not accommodate the mobility of the SSs at all. In contrast, the IEEE 802.16e communication system accommodates the mobility of an SS in the IEEE 802.16a communication system. Herein, an SS having mobility is referred to as a Mobile Subscriber Station (MSS).

Additionally, the IEEE 802.16e communication system supports two communication modes, i.e., a Point-to-Multi-point (PMP) mode and a mesh mode.

In the PMP mode, all SSs communicate with one Base Station (BS) and all data is transmitted through an uplink and a downlink in communication with the BS. In the PMP mode, synchronization is acquired by performing a ranging operation between the SS and the BS, and communication is performed between the SS and the BS through a message exchange.

In the mesh mode, there are no obvious differences between an uplink and a downlink when compared with the PMP mode, and all nodes can set their respective connections by exchanging a control message even between the SSs as well as the BS.

FIG. 1 is a flow diagram illustrating a conventional method for setting a connection between nodes when the IEEE 802.16a communication system performs mesh communication. Referring to FIG. 1, neighbor nodes, i.e., a first neighbor node 150 and a second neighbor node 160, transmit mesh-network configuration (MSH-NCFG) messages including mesh-network configuration information thereof in steps 120 and 122. The MSH-NCFG message is used when a BS and SSs performing the mesh communication acquire network synchronization. Further, the MSH-NCFG message includes information of neighbor nodes, list information of BSs to which each of the neighbor nodes is connected, etc.

The MSH-NCFG message has a structure as shown in Table 1 below.

TABLE 1

| Syntax | Size | Notes |
|---|---|---|
| MSH-NCFG_Message_Format( ){ | | |
| Management Message type = 39 | 8 bits | |
| NumNbrEntries | 5 bits | |
| NumBSEntries | 2 bits | |
| Embedded Packet Flag | 1 bit | 0 = Not present, |
| | | 1= present |
| XmtPower | 4 bits | |
| XmtAntenna | 3 bits | |
| NetEntry MAC Address Flag | 1 bit | 0 = Not present, |
| | | 1= present |
| Network base channel | 4 bits | |
| Reserved | 4 bits | |
| NetConfig Count | 4 bits | |
| Timestamp | | |
| Frame Number | 12 bits | See 8.2.3.2 |
| Network Control Slot Number in frame | 4 bits | |
| Synchronization Hop Count | 8 bits | |
| NetConfig schedule info | | |
| Next Xmt Mx | 3 bits | |
| Xmt Holdoff Exponent | 5 bits | |
| if (NetEntry MAC Address Flag) | | |
| NetEntry MAC Address | 48 bits | |
| for (i=0;i<NumBSEntries;++i) { | | |
| BSNodeID | 16 bits | |
| Number of hops | 3 bits | |
| Xmt energy/bit | 5 bits | |
| } | | |
| for (i=0;i<NumNbrEntries;++i) { | | |
| NbrNodeID | 16 bits | |
| MSH-Nbr_Physical_IE( ) | 16 bits | See Table 65. |
| if (Logical Link Info Present Flag) | 16 bits | See Table 65. |
| MSH-Nbr_Logical_IE( ) | | See Table 66. |
| } | | |
| if (Embedded Packet Flag) | variable | See Table 67. |
| MSH-NCFG_embedded_data( ) | | |
| } | | |

As shown in Table 1, the MSH-NCFG message includes a plurality of information elements (IEs), e.g., a Management Message Type representing the types of transmitted messages, a NumNbrEntries representing the number of neighbor nodes, a NumBSEntries representing the number of neighbor BSs, an XmtPower representing transmit power of the MSH-NCFG message, an XmtAntenna representing logic antenna information used for transmitting the MSH-NCFG message, a NbrNodeID representing identifiers of neighbor nodes belonging to the NumNbrEntries, an MSH-Nbr_Physical_IE representing physical link information of the neighbor nodes, an MSH-Nbr_Logical_IE representing logical link information of the neighbor nodes, a BSNodeID representing identifiers of neighbor BSs belonging to the NumBSEntries, a Numberofhops representing the number of hops up to the neighbor BS, an XmtEnergy/bit representing energy/bit information required for transmitting a message to the neighbor BS, and an MSH-NCFG_embedded_data representing insertion data of the MSH-NCFG message.

The MSH-NCFG_embedded_data included in the MSH-NCFG message has a structure as shown in Table 2 below.

TABLE 2

| Syntax | Size | Notes |
|---|---|---|
| MSH-NCFG_embedded_data( ){ | | |
| Extended embedded_data | 1 bit | Indicates whether this |
| | | embedded IE is |
| | | followed by another one |
| | | 0 = No, 1 = Yes |
| Reserved | 3 bits | |
| Type | 4 bits | |
| Length | 8 bits | Length of embedded_IE |
| | | in bytes, exclusive |
| | | this header |
| Embedded_data_IE( ) | variable | Type dependent |
| } | | |

As shown in Table 2, the MSH-NCFG_embedded_data of the MSH-NCFG message includes a plurality of IEs, e.g., a Type representing the types of data included in the MSH-NCFG message and an Embedded_data_IE representing IEs of the data included in the MSH-NCFG message. The Type can include, for example, a Network Entry Open, a Network Entry Reject, and a Network Entry Ack. When the MSH-NCFG_embedded_data is the Network Entry Open type, the MSH-NCFG_embedded_data has a structure as shown in Table 3 below.

TABLE 3

| Syntax | Size | Notes |
|---|---|---|
| MSH-NCFG_embedded_data_IE( ){ | | |
| Minislot Start | 8 bits | Schedule start for |
| | | upper layer |
| | | network entry |
| Minislot Range | 8 bits | Schedule range for |
| | | upper layer |
| | | network entry |
| Frame number | 12 bits | Frame number |
| | | this schedule |
| | | becomes valid |
| Channel | 4 bits | Logical channel |
| | | for new node to |
| | | Xmt in above |
| | | Minislot Range |
| Schedule validity | 12 bits | Validity of |
| | | Schedule in frames |
| Channel | 4 bits | Logical Rcv channel |
| | | for new node |
| Estimated Propagation Delay | 4 bits | μS |
| Reserved | 4 bits | |
| } | | |

As shown in Table 3, the MSH-NCFG_embedded_data of the Network Entry Open type includes a plurality of IEs, e.g., a Minislot Start representing a start time point of a network entry scheduling, a Minislot Range representing a range of the network entry scheduling, a Frame number representing a frame number in which the network entry scheduling is valid, and a Channel representing transmission channel information and reception channel information used in the Minislot Range.

When the MSH-NCFG_embedded_data is the Network Entry Reject type, the MSH-NCFG_embedded_data has a structure as shown in Table 4 below.

TABLE 4

| Syntax | Size | Notes |
|---|---|---|
| MSH-NCFG_embedded_data_IE( ){ | | |
| Rejection Code | 8 bits | |
| Rejection Reason | 160 bits | ASCII string |
| } | | |

As shown in Table 4, the MSH-NCFG_embedded_data of the Network Entry Reject type includes a Rejection Code representing a rejection reason.

An SS 110, which is to join the IEEE 802.16a communication system, receives the MSH-NCFG messages transmitted from the first neighbor node 150 and the second neighbor node 160, and acquires a network parameter and generates a neighbor node list in step 124. The SS 110 selects one neighbor node, for example, the first neighbor node 150, as a candidate sponsoring node from the neighbor node list, and acquires a coarse synchronization with the first neighbor node 150 in step 126.

The SS 110 transmits a mesh network entry:network entry request (MSH-NENT:NETENTRYREQUEST) message to the first neighbor node 150 in step 128. The MSH-NENT:NETENTRYREQUEST message is a kind of a mesh network entry (MSH-NENT) message. That is, the MSH-NENT:NETENTRYREQUEST message is a message used for allowing a node newly entering (or joining) a network using the mesh communication to acquire synchronization with other nodes in the mesh network and to join the mesh network. The MSH-NENT message has a structure as shown in Table 5 below.

TABLE 5

| Syntax | Size | Notes |
|---|---|---|
| MSH-NENT_message_Format( ){ | | |
| Management Message type = 40 | 8 bits | |
| Type | 3 bits | 0x0 Reserved |
| | | 0x1 NetEntry-Ack |
| | | 0x2 NetEntry-Request |
| | | 0x3 NetEntry-Close |
| Xmt counter for this Type | 3 bits | For NetEntryAck, |
| | | this is the Type |
| | | being acknowledged. |
| Reserved | 2 bits | |
| Sponsor Node ID | 16 bits | |
| Xmt Power | 4 bits | |
| Xmt Antenna | 3 bits | |
| Reserved | 1 bit | |
| if (Type == 0x2) | | |
| MSH_NENT_Request_IE( ) | variable | |
| } | | |

As shown in Table 5, the MSH-NENT message includes a plurality of IEs, e.g., a Management Message Type representing the types of transmitted messages, a Type representing the types of information included in the MSH-NENT message, an Xmt counter representing transmission counter information of the Type, a Sponsor Node ID representing identifiers of a sponsor node, and an MSH-NENT_Request_IE representing mesh network entry request information.

The MSH-NENT_Request_IE has a structure as shown in Table 6 below.

TABLE 6

| Syntax | Size | Notes |
|---|---|---|
| MSH-NENT_Request_IE( ){ | | |
| MAC Address | 48 bits | |
| OpConfInfo | 64 bits | |
| Operator Authentication Value | 32 bits | |
| Node serial Number | 32 bits | |
| } | | |

As shown in Table 6, the MSH-NENT_Request_IE is an IE activated when an MSH-NENT:NetEntryRequest, which is a type of MSH-NENT message, has been set. The MSH-NENT_Request_IE includes, for example, a Medium Access Control (MAC) Address representing an MAC Address of a node transmitting the MSH-NENT:NETENTRYREQUEST message, operator configuration information (OpConfInfo) representing configuration information provided by an operator, and an operator authentication value representing an authentication value by the operator.

After receiving the MSH-NENT:NETENTRYREQUEST message, the first neighbor node 150 transmits a mesh network configuration:network entry open (MSH-NCFG:NETENTRYOPEN) message, which is a response message of the MSH-NENT:NETENTRYREQUEST message, in step 130. When the first neighbor node 150 approves the network entry request of the SS 110, the first neighbor node 150 inserts the MAC address of the SS 110 into the MSH-NCFG:NETENTRYOPEN message. The MAC address of the SS 110 is included in the MSH-NCFG message transmitted from the first neighbor node 150 until the mesh communication connection with the first neighbor node 150 is ended.

The SS 110 acquires a fine time synchronization with the first neighbor node 150 by receiving the MSH-NCFG:NETENTRYOPEN message from the first neighbor node 150. Further, the SS 110 transmits a mesh network entry:network entry acknowledge (MSH-NENT:NETENTRYACK) message, which is a response message of the MSH-NCFG:NETENTRYOPEN message, to the first neighbor node 150 in step 132. Through the steps as described above, a sponsor channel is set up between the SS 110 and the first neighbor node 150 in step 134.

As a result, the first neighbor node 150 operates as a sponsor node of the SS 110 and enables the SS 110 to join the mesh network. The SS 110 performs a network entry operation such as authentication and an SS basic support information exchange through the setup sponsor channel in step 136.

After performing the network entry operation, the SS 110 transmits a mesh network entry:network entry close (MSH-NENT:NETENTRYCLOSE) message, which represents the close of the network entry operation, to the first neighbor node 150 in step 138.

After receiving the MSH-NENT:NETENTRYCLOSE message from the SS 110, the first neighbor node 150 transmits a mesh network entry:network entry acknowledge (MSH-NENT:NETENTRYACK) message, which is a response message of the MSH-NCFG:NETENTRYCLOSE message, to the SS 110 in step 140. Thereafter, the mesh network entry operation ends.

As illustrated in FIG. 1, because the mesh mode of the IEEE 802.16a communication system does not accommodate the mobility of the SS, the mesh mode accommodates neither the mobility support of the SS nor handover according to the movement of the SS. Further, the IEEE 802.16e communication system accommodates the mobility support and handover of the MSS based on the mobility of the SS as described above, but it does not accommodate the mesh mode. Therefore, it is necessary to implement the mesh mode and handover of an MSS in the mesh mode for the IEEE 802.16e communication system.

### SUMMARY OF THE INVENTION

Accordingly, the present invention has been designed to solve the above and other problems occurring in the prior art. It is an object of the present invention to provide a handover method in a BWA communication system using a mesh mode.

It is another object of the present invention to provide a method for performing intra-cell handover in a BWA communication system.

It is further another object of the present invention to provide a method for performing inter-cell handover in a BWA communication system.

In order to accomplish the above and other objects, according to an aspect of the present invention, there is provided a method for handover in a Broadband Wireless Access (BWA) communication system, the BWA communication system including a plurality of Mobile Subscriber Stations (MSSs), a serving Base Station (BS) for providing a communication service to the MSSs, and a plurality of sponsor nodes connected between the MSSs and the serving BS for providing the communication service to the MSSs. The method comprises the steps of: detecting, by an MSS, a need to handover while communicating with the serving BS; transmitting, by the MSS, a handover request to the serving BS; receiving, by the serving BS, the handover request from the MSS; selecting, by the serving BS, one of the plurality of sponsor nodes as a target sponsor node to which the MSS will handover; and notifying the MSS that the MSS shall perform the handover to the target sponsor node.

According to another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs. The method comprises the steps of: detecting, by the MSS, a need to handover, while performing direct communication with the serving BS; transmitting, by the MSS, a handover request to the serving BS; receiving, by the MSS, a notification that the MSS shall perform the handover to a target sponsor node selected from the plurality of sponsor nodes, from the serving BS, in response to the handover request; and notifying the serving BS that the MSS will perform the handover to the target sponsor node from the serving BS.

According to further another aspect of the present, there is provided a method for handover of a serving Base Station (BS) in a Broadband Wireless Access (BWA) communication system, the BWA communication system including a plurality of Mobile Subscriber Stations (MSSs), the BS for providing a communication service to the MSSs, and a plurality of sponsor nodes connected between the MSSs and the serving BS for providing the communication service to the MSSs. The method comprises the steps of receiving, by the BS, a handover request from the MSS; selecting one of the plurality of sponsor nodes as a target sponsor node to which the MSS will perform the handover; and notifying the MSS that the MSS shall perform the handover to the target sponsor node from the BS.

According to still another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs. The method comprises the steps of: detecting, by the MSS a need to handover while communicating with a serving sponsor node; transmitting a handover request to the serving BS through the serving sponsor node; receiving a notification that the MSS shall perform the handover to the serving BS through the serving sponsor node, in response to the handover request; and notifying the serving BS through the serving sponsor node that the MSS will perform the handover to the serving BS.

According to yet another aspect of the present, there is provided a method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs. The method comprises the steps of: receiving, by an serving sponsor node of providing communication service to the MSS, a handover request from the MSS; notifying the serving BS of the handover request of the MSS; receiving a notification from the serving BS that the MSS shall perform a handover to the serving BS, in response to the handover request; notifying the MSS that the MSS shall perform the handover to the serving BS from the serving sponsor node; receiving a notification from the MSS that the MSS will perform the handover to the serving BS from the serving sponsor node; and notifying the serving BS that the MSS will perform the handover to the serving BS from the serving sponsor node.

According to yet another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs. The method comprises the steps of: detecting, by the MSS, a need to handover while communicating with a serving sponsor node; transmitting a handover request to the serving BS through the serving sponsor node; receiving a notification that the MSS shall perform the handover to a target sponsor node selected from neighbor sponsor nodes, from the serving BS, through the serving sponsor node, in response to the handover request; and notifying the serving BS through the serving sponsor node that the MSS will perform the handover to the target sponsor node from the serving sponsor node.

According to yet another aspect of the present, there is provided a method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs. The method comprises the steps of: receiving, by an serving sponsor node of providing communication service to the MSS, a handover request from the MSS; notifying the serving BS of the handover request of the MSS; receiving a notification that the MSS shall perform a handover to a target sponsor node selected from neighbor sponsor nodes, from the serving BS, in response to the handover request; notifying the MSS that the MSS shall perform the handover to the target sponsor node from the serving sponsor node; receiving a notification that the MSS will perform the handover to the target sponsor node from the serving sponsor node from the MSS; and notifying the serving BS that the MSS will perform the handover to the target sponsor node from the serving sponsor node.

According to yet another aspect of the present, there is provided a method for handover in a Broadband Wireless Access (BWA) communication system, the BWA communication system including a plurality of Mobile Subscriber Stations (MSSs), a serving Base Station (BS) for providing a communication service to the MSSs, a plurality of neighbor BSs that are different from the serving BS, and a plurality of sponsor nodes connected between the MSSs and the serving BS or between the MSSs and each of the neighbor BSs for providing the communication service to the MSSs. The method comprises the steps of: detecting, by the MSS, a need to handover while communicating with the serving BS; transmitting, by the MSS, a handover request to the serving BS; selecting, by the serving BS, one of the plurality of sponsor nodes of a target BS belonging to the plurality of neighbor BSs as a target sponsor node to which the MSS will perform handover; notifying the MSS that the MSS shall perform the handover to the target sponsor node from the serving BS; and notifying the serving BS that the MSS will perform the handover to the target sponsor node.

According to yet another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: detecting, by the MSS, a need to handover while performing direct communication with the serving BS; transmitting a handover request to the serving BS; receiving a notification that the MSS shall perform the handover to a target sponsor node selected from the plurality of sponsor nodes of a target BS belonging to the neighbor BSs; and notifying the serving BS that the MSS will perform the handover to the target sponsor node from the serving BS.

According to yet another aspect of the present, there is provided a method for handover of a serving Base Station (BS) in a Broadband Wireless Access (BWA) communication system, the BWA communication system including a plurality of Mobile Subscriber Stations (MSSs), the serving BS for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: receiving, by the serving BS, a handover request from an MSS; selecting one of the plurality of sponsor nodes of a target BS belonging to the neighbor BSs as a target sponsor node to which the MSS will perform handover; and notifying the MSS that the MSS shall perform the handover to the target sponsor node from the serving BS.

According to yet another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: detecting, by the MSS, a need to handover while communicating with a serving sponsor node; transmitting a handover request to the serving BS through the serving sponsor node; receiving a notification that the MSS shall perform the handover to a target BS selected from the plurality of neighbor BSs, from the serving BS through the serving sponsor node in response to the handover request; and notifying the serving BS through the serving sponsor node that the MSS will perform the handover to the target BS from the serving sponsor node.

According to yet another aspect of the present, there is provided a method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing the communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: receiving, by an serving sponsor node of providing communication service to the MSS, a handover request from the MSS; notifying the serving BS of the handover request of the MSS; receiving a notification that the MSS shall perform handover to a target BS selected from the neighbor BSs, from the serving BS, in response to a notification of the handover request; and notifying the MSS of the handover to the target BS from the serving sponsor node.

According to yet another aspect of the present, there is provided a method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: detecting, by the MSS, a need to handover while communicating with a serving sponsor node; transmitting a handover request to the serving BS through the serving sponsor node; receiving a notification that the MSS shall perform the handover to a target sponsor node selected from the plurality of neighbor sponsor nodes of a target BS belonging to the neighbor BSs, from the serving BS through the serving sponsor node, in response to the handover request; and notifying the serving BS through the serving sponsor node that the MSS will perform the handover to the target sponsor node from the serving sponsor node.

According to yet another aspect of the present, there is provided a method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing the communication service to the MSSs, a plurality of neighbor BSs different from the serving BS, and a plurality of sponsor nodes connected between the MSSs and the serving BS or between the MSSs and each of the neighbor BSs for providing the communication service to the MSSs. The method comprises the steps of: receiving, by an serving sponsor node of providing communication service to the MSS, a handover request from the MSS; notifying the serving BS of the handover request of the MSS; receiving a notification that the MSS shall perform handover to a target sponsor node selected from the plurality of sponsor nodes of a target BS belonging to the neighbor BSs, from the serving BS, in response to a notification of the handover request; and notifying the MSS of the handover to the target sponsor node from the serving sponsor node.

### BRIEF DESCRIPTION OF THE DRAWINGS

The above and other objects, features, and advantages of the present invention will be more apparent from the following detailed description taken in conjunction with the accompanying drawings, in which:

FIG. 1 is a flow diagram illustrating a conventional method for setting a connection between nodes when an IEEE 802.16a communication system performs mesh communication;

FIG. 2 is a diagram schematically illustrating a mesh IEEE 802.16e communication system according to the present invention;

FIG. 3 is a diagram schematically illustrating an intra-cell D2M handover operation in a mesh IEEE 802.16e communication system according to a first embodiment of the present invention;

FIG. 4 is a flow diagram illustrating an intra-cell D2M handover operation in a mesh IEEE 802.16e communication system according to the first embodiment of the present invention;

FIG. 5 is a flow diagram illustrating the scanning and handover determination (step 419) operation process of FIG. 4;

FIG. 6 is a diagram schematically illustrating an intra-cell M2D handover operation in a mesh IEEE 802.16e communication system according to a second embodiment of the present invention;

FIG. 7 is a flow diagram illustrating an intra-cell M2D handover operation in a mesh IEEE 802.16e communication system according to the second embodiment of the present invention;

FIG. 8 is a diagram schematically illustrating an intra-cell M2M handover operation in a mesh IEEE 802.16e communication system according to a third embodiment of the present invention;

FIG. 9 is a flow diagram illustrating an intra-cell M2M handover operation in a mesh IEEE 802.16e communication system according to the third embodiment of the present invention;

FIG. 10 is a diagram schematically illustrating an inter-cell D2M handover operation in a mesh IEEE 802.16e communication system according to a fourth embodiment of the present invention;

FIGS. 11A and 11B are flow diagrams illustrating an inter-cell D2M handover operation in a mesh IEEE 802.16e communication system according to a fourth embodiment of the present invention;

FIG. 12 is a diagram schematically illustrating an inter-cell M2D handover operation in a mesh IEEE 802.16e communication system according to a fifth embodiment of the present invention;

FIGS. 13A and 13B are flow diagrams illustrating an inter-cell M2D handover operation in a mesh IEEE 802.16e communication system according to the fifth embodiment of the present invention;

FIG. 14 is a diagram schematically illustrating an inter-cell M2M handover operation in a mesh IEEE 802.16e communication system according to a sixth embodiment of the present invention;

FIGS. 15A and 15B are flow diagrams illustrating an inter-cell M2M handover operation in a mesh IEEE 802.16e communication system according to the sixth embodiment of the present invention;

FIG. 16 is a diagram schematically illustrating an inter-cell D2D handover operation in a mesh IEEE 802.16e communication system according to a seventh embodiment of the present invention; and

FIGS. 17A and 17B are flow diagrams illustrating an inter-cell D2D handover operation in a mesh IEEE 802.16e communication system according to the seventh embodiment of the present invention.

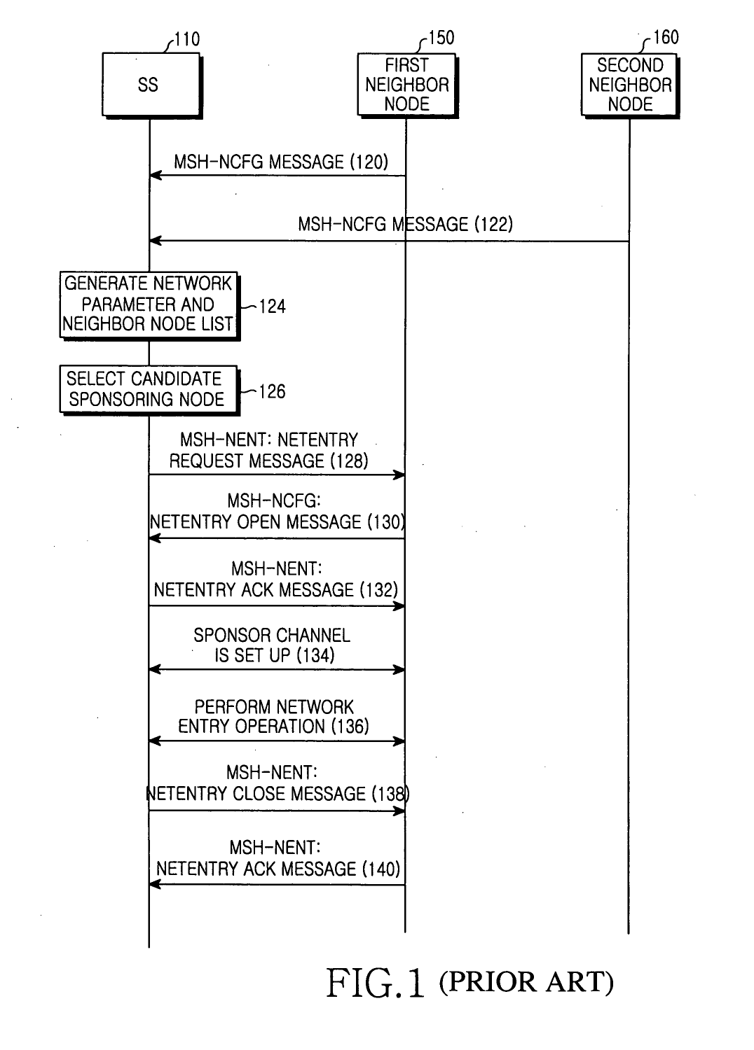

### DETAILED DESCRIPTION OF THE PREFERRED EMBODIMENT

Preferred embodiments of the present invention will be described in detail herein below with reference to the accompanying drawings. In the following description, a detailed description of known functions and configurations incorporated herein will be omitted when it may obscure the subject matter of the present invention.

The present invention proposes a handover scheme when an MSS is in a mesh mode in an IEEE 802.16e communication system. The IEEE 802.16e communication system is a BWA communication system using an OFDM scheme and an OFDMA scheme. Because the IEEE 802.16e communication system uses the OFDM scheme and the OFDMA scheme, it transmits physical channel signals using multiple sub-carriers. Accordingly, the IEEE 802.16e communication system can transmit data at high speed.

Further, the IEEE 802.16e communication system accommodates a multi-cell structure, so that it can accommodate the mobility of an MSS.

In the present invention, the IEEE 802.16e communication system is described, for example, as the BWA communication system. However, it will be apparent to those who skilled in the art that the present invention can be applied to all communication systems using the mesh mode as well as the IEEE 802.16e communication system.

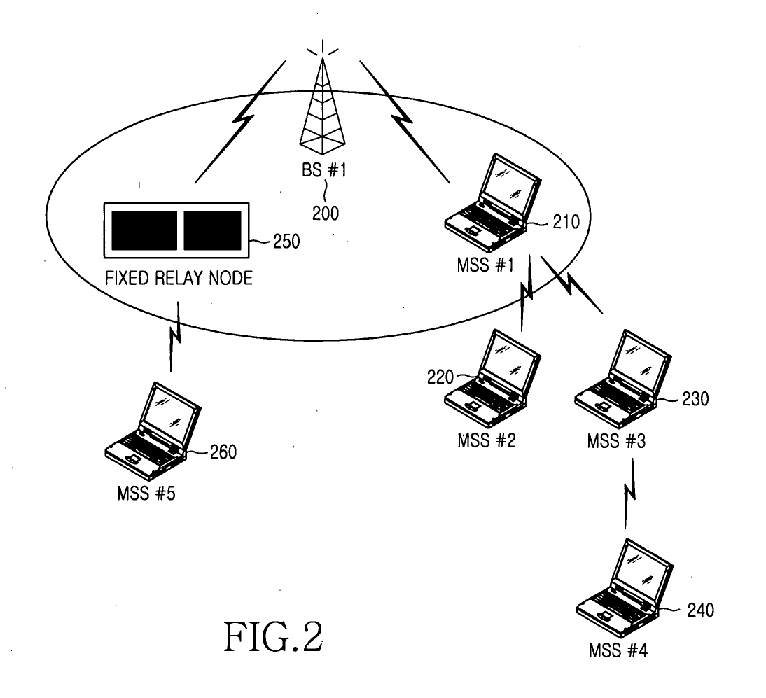

FIG. 2 is a diagram schematically showing the structure of the IEEE 802.16e communication system (mesh IEEE 802.16e communication system) performing the mesh communication. Before describing FIG. 2, the IEEE 802.16e communication system is a communication system accommodating the mobility of an SS in an IEEE 802.16a communication system as described in the prior art. However, the mesh communication has not been proposed in detail yet. Accordingly, the embodiment of the present invention proposes the structure of the mesh IEEE 802.16e communication system as illustrated in FIG. 2.

Referring to FIG. 2, in the mesh IEEE 802.16e communication system, all nodes except for a BS can have mobility. Further, the mesh IEEE 802.16e communication system supports not only direct communication between the BS and a fixed SS or an MSS, but also mesh communication passing through an intermediate node. An MSS 210 communications directly with a BS 200, and an MSS 260 performs mesh communication with the BS 200 through a fixed relay node 250. MSSs 220 and 230, which are relay nodes having mobility, communicate with the BS 200 through the MSS 210, and an MSS 240 communicates with the BS 200 through two nodes, i.e., the MSSs 210 and 230.

Further, the mesh IEEE 802.16e communication system accommodates the multi-cell structure. In FIG. 2, a plurality of single cells are combined to form the multi-cell structure.

Furthermore, the mesh IEEE 802.16e communication system also accommodates handover between the cells.

In the mesh IEEE 802.16e communication system as illustrated in FIG. 2, the relay node may include a fixed node or a mobile node. However, if it is assumed that all nodes have the mobility, it actually means that a relay node is a fixed delivery node. Accordingly, in the following description, it is assumed that all nodes except for a BS have mobility in the following description.

In FIG. 2, a node (i.e., the MSS 210, the MSS 230, and the fixed relay node 250) functioning as a relay node will be referred to as a sponsor node because the relay node (or sponsor node) functions as a kind of BS for other nodes. In the present invention, the sponsor node performs the same role as that of a sponsor node in the mesh mode of the IEEE 802.16a communication system, except that the sponsor node of the present invention accommodates the mobility.

In the present invention, when an MSS is directly connected to and communicates with a BS, this connection will be referred to as a ‘direct connection’. However, when the MSS communicates with the BS through another node, instead of being directly connected to the BS, this connection will be referred to as a ‘mesh connection’. Further, the communication in the former case will be referred to as a ‘direct communication’ and the communication in the latter case will be referred to as a ‘mesh communication’.

The mesh IEEE 802.16e communication system can consider various handover scenarios, different from a handover scheme provided by the IEEE 802.16e communication system (PMP IEEE 802.16e communication system) using a PMP mode. More specifically, the present invention proposes a handover scheme considering the total seven handover scenarios capable of occurring in the mesh IEEE 802.16e communication system.

However, before a description of the seven handover scenarios is given, handover situations capable of occurring in the mesh IEEE 802.16e communication system will be described.

When a handover is performed in the same cell, i.e., when the handover is performed, this may occur without changing the BS communicating.

In the PMP IEEE 802.16e communication system, if an MSS moves in the same cell, it is not necessary to separately perform the handover because the MSS continuously communicates with the same BS. However, in the mesh IEEE 802.16e communication system, if a sponsor node changes, even though the MSS moves in the same cell, it is necessary to newly set a connection of the MSS. Accordingly, a handover must be performed. In this case, the handover caused by the change of the sponsor node will be referred to as an ‘intra-cell handover’. The intra-cell handover may be classified into three scenarios and the three scenarios will be described in more detail later.

When handover is performed between different cells, i.e., when the handover is performed due to change of a BS being in communication, this may occur without classification between the direct communication and the mesh communication. This handover will be referred to as an ‘inter-cell handover’ because the handover is performed between the different cells. The inter-cell handover may also be classified into four scenarios and the four scenarios will also be described in more detail later.

As a result, criteria for the intra-cell handover and the inter-cell handover is determined according to whether a sponsor node (i.e. target sponsor node) to which the MSS is to be handed over exists in the same cell as that in which a current sponsor node, i.e., a serving sponsor node, exists. That is, when the MSS transmits a handover request message, the message is transmitted to a serving BS via the current serving sponsor node. The serving BS knows if the sponsor node to which the MSS is to be handed over exists in the same cell as that in which the current serving sponsor node exists with reference to the handover request message. Accordingly, the serving BS can determine if the handover of the MSS is the intra-cell handover or the inter-cell handover. Criteria for handovers classified in detail in each of the intra-cell handover and the inter-cell handover are determined according to whether the serving sponsor node or a new sponsor node, i.e., target sponsor node, to which the MSS is to move is a BS or an MSS.

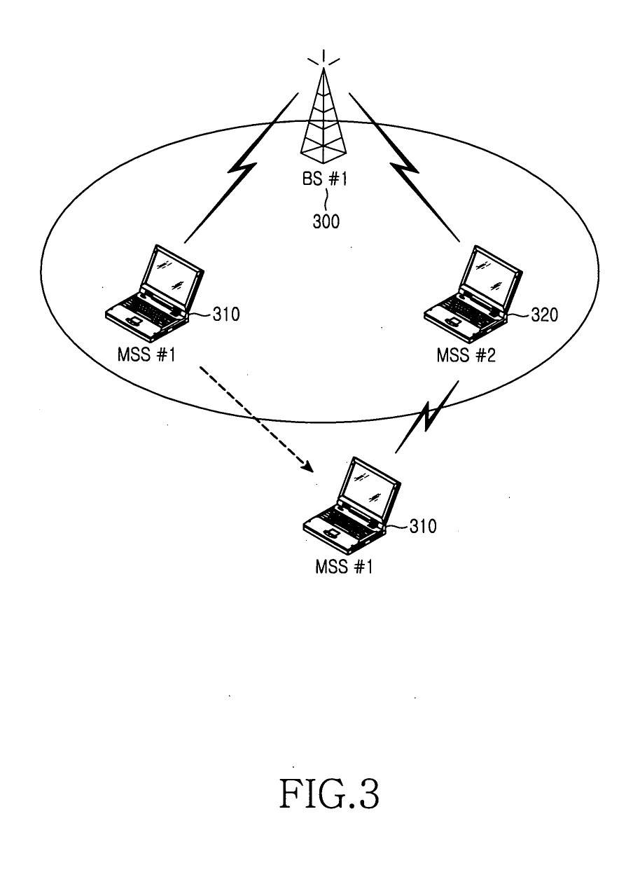

FIG. 3 illustrates an MSS in direct communication that performs an intra-cell handover (intra-cell Direct-to-Mesh (D2M) handover) for mesh communication with another MSS in the mesh IEEE 802.16e communication system. More specifically, FIG. 3 is a diagram schematically illustrating the intra-cell D2M handover operation in the mesh IEEE 802.16e communication system according to the first embodiment of the present invention.

Referring to FIG. 3, a BS 300 is a BS and a serving sponsor node to which an MSS 310 is currently connected. An MSS 320 is a target sponsor node to which the MSS 310 is to be newly connected, i.e., the MSS 310 is to be handed over. When the MSS 310 detects a need to handover during direct communication with the BS 300, the MSS 310 sets the MSS 320 as the target sponsor node and performs mesh communication with the BS 300. As illustrated in FIG. 3, because the sponsor node of the MSS 310 changes and the BS 300 does not change, the intra-cell D2M handover becomes the intra-cell handover.

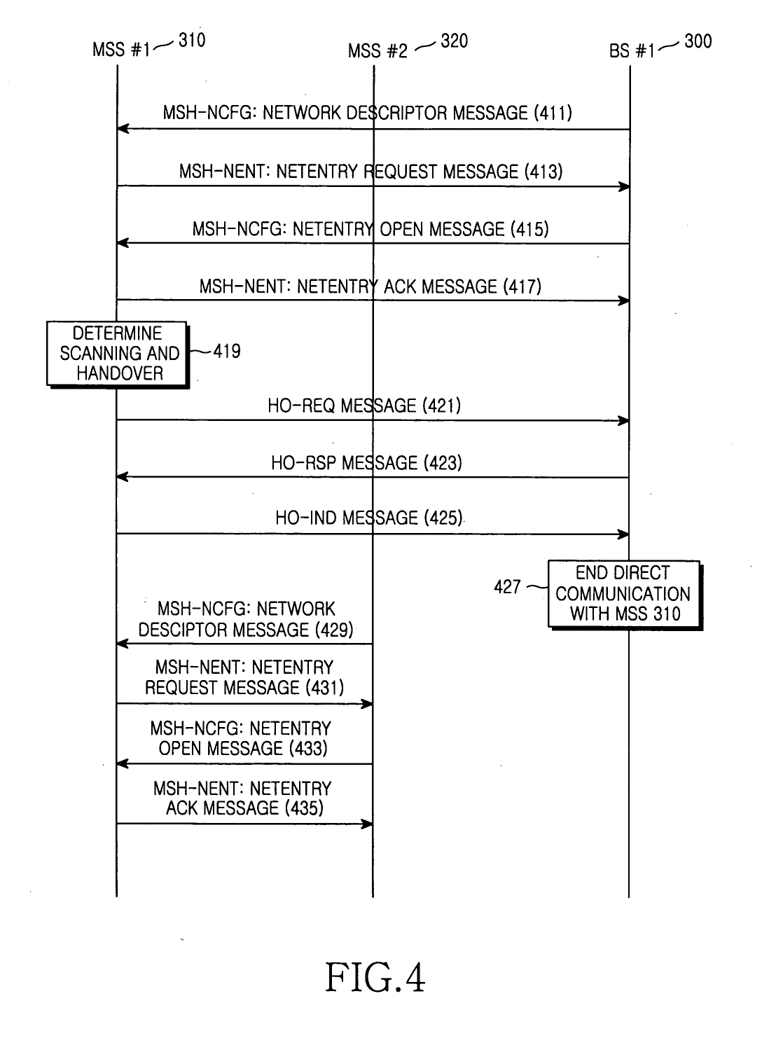

FIG. 4 is a flow diagram illustrating an intra-cell D2M handover operation in a mesh IEEE 802.16e communication system according to the first embodiment of the present invention. Referring to FIG. 4, in step 411, the MSS 310 receives a mesh network configuration:network descriptor (MSH-NCFG:NETWORK DESCRIPTOR) message transmitted from the BS 300 because the MSS 310 performs the direct communication with the BS 300 as illustrated in FIG. 3. The MSH-NCFG:NETWORK DESCRIPTOR message is a kind of an MSH-NCFG message newly proposed by the present invention, and has a structure obtained by changing the structure of the MSH-NCFG message used in the IEEE 802.16a communication system. The MSH-NCFG:NETWORK DESCRIPTOR has a structure as shown in Table 7 below.

TABLE 7

| Syntax | Notes |
|---|---|
| MSH-NCFG_message_Format( ){ | |
| Node ID | Identifier of corresponding node |
| Serving BS Node ID | Serving BS identifier when |
| | corresponding node is MSS |
| Number of hops | Number of hops up to serving |
| | BS when corresponding node |
| | is MSS |
| Measured Data rate | measured value of Data rate |
| | with serving BS when |
| | corresponding node is MSS |
| Time stamp | It is possible to acquire |
| | synchronization with |
| | corresponding candidate |
| | through corresponding field |
| } | |

As shown in Table 7, the MSH-NCFG:NETWORK DESCRIPTOR message includes a plurality of IEs, i.e., the Node ID representing an identifier of a node transmitting the MSH-NCFG:NETWORK DESCRIPTOR message, the Serving BS Node ID representing a serving BS identifier of the MSS when the node transmitting the MSH-NCFG:NETWORK DESCRIPTOR message is the MSS, the Number of hops representing information for the number of hops up to the serving BS, the Measured Data rate representing a data rate with the serving BS, and the Time stamp for acquiring synchronization with a candidate sponsor node.

In step 413, the MSS 310 transmits an MSH-NENT:NETENTRYREQUEST message to the BS 300. The MSH-NENT:NETENTRYREQUEST message is a kind of the MSH-NENT message and is a message used for allowing a node newly entering (or joining) a network using the mesh communication to acquire synchronization with other nodes in the mesh network and to join the mesh network.

After receiving the MSH-NENT:NETENTRYREQUEST message, the BS 300 transmits an MSH-NCFG:NETENTRYOPEN message to the MSS 310 in response to the MSH-NENT:NETENTRYREQUEST message in step 415. When the BS 300 approves the network entry request of the MSS 310, the BS 300 inserts the MAC address of the MSS 310 into the MSH-NCFG:NETENTRYOPEN message. The MAC address of the MSS 310 is included in the MSH-NCFG message transmitted from the BS 300 until the mesh communication connection with the BS 300 is ended.

The MSS 310 acquires a fine time synchronization with the BS 300 by receiving the MSH-NCFG:NETENTRYOPEN message from the BS 300. Further, the MSS 310 transmits an MSH-NENT:NETENTRYACK message, which is a response message of the MSH-NCFG:NETENTRYOPEN message, to the BS 300 in step 417. Through the steps as described above, a sponsor channel is set up between the MSS 310 and the BS 300. As a result, the BS 300 operates as a sponsor node of the MSS 310 and enables the MSS 310 to join the mesh network.

After the MSS 310 has joined the mesh network in this way, the MSS 310 continuously scans neighbor nodes and determines handover based on the scanning result in step 419. That is, the MSS 310 determines whether to be handed over to another node, i.e., the target sponsor node from the serving sponsor node, i.e., the BS 300, using a measurement result for a Signal-to-Interference-and-Noise-Ratio (SINR) of a signal received from the serving sponsor node and a scanning result for SINRs of the neighbor nodes. Because the process for determining the handover is to be described in detail later, the detailed description will be omitted here.

After determining the handover, the MSS 310 transmits a HandOver Request (HO-REQ) message, which includes information for nodes (candidate sponsor nodes) capable of being selected as the target sponsor node by the MSS 310, to the BS 300 in step 421. The HO-REQ message also is a message newly proposed by the present invention, which has a structure as shown in Table 8 below.

TABLE 8

| Syntax | Notes |
|---|---|
| HO-REQ_message_Format( ){ | |
| N_Recommended | Number of candidate sponsor |
| | nodes recommended to BS by |
| | MSS |
| For (j=0;j<N_Recommended;j++) { | |
| Candidate Sponsor ID | Identifier of candidate sponsor |
| | node understood through |
| | MSH-NCFG message |
| Candidate Sponsor's Serving BS ID (if | When candidate sponsor node |
| exists) | is BS, this field is empty. |
| | When candidate sponsor node |
| | is MSS, serving BS ID of |
| | corresponding MSS is written. |
| Candidate Sponsor S/(N+I) | SINR with specific candidate |
| | sponsor |
| } | |
| } | |

As shown in Table 8, the HO-REQ message includes a plurality of IEs, i.e., the N_Recommended representing the number of candidate sponsor nodes recommended by the MSS and information for each of the candidate sponsor nodes included in the N_Recommended. The information of the candidate sponsor node includes the Candidate Sponsor ID representing the identifier of the candidate sponsor node, the Candidate Sponsor S/(N+I) representing an SINR of a signal received in the candidate sponsor node, and the Candidate Sponsor Serving BS ID representing the serving BS identifier of the candidate sponsor node. When the candidate sponsor node is the MSS, the Candidate Sponsor Serving BS ID field includes the serving BS identifier. However, when the candidate sponsor node is the BS, the Candidate Sponsor Serving BS ID field does not include a separate value.

After receiving the HO-REQ message from the MSS 310, the BS 300 selects an optimal candidate sponsor node, i.e., target sponsor node, of the candidate sponsor nodes included in the N_Recommended of the HO-REQ message. Because the operation for selecting the target sponsor node of the candidate sponsor nodes is to be described in detail later, the detailed description will be omitted here.

It is assumed that the BS 300 selects the MSS 320 as the target sponsor node in FIG. 4. The BS 300 having selected the MSS 320 as the target sponsor node recognizes that a serving BS of the MSS 320 is the BS 300 and determines the handover of the MSS 310 is the intra-cell D2M handover. Accordingly, the BS 300 transmits a HandOver Response (HO-RSP) message including information for the selected MSS 320 to the MSS 310 in step 423. The HO-RSP message is also a message newly proposed by the present invention, and has a structure as shown in Table 9 below.

TABLE 9

| Syntax | Notes |
|---|---|
| HO-RSP_message_Format( ){ | |
| N_Recommended | Number of candidate sponsor |
| | nodes recommended to BS |
| | by MSS |
| For (j=0;j<N_Recommended;j++) { | Inform MSS of candidate |
| | sponsor nodes most suitable for |
| | handover of the MSS |
| Candidate Sponsor ID | Identifier of candidate sponsor |
| | node understood through |
| | MSH-NCFG message |
| Candidate Sponsor's Serving BS ID (if | When candidate sponsor |
| exists) | node is BS, this field is empty. |
| | When candidate sponsor node |
| | is MSS, serving BS ID of |
| | corresponding MSS is written. |
| } | |
| } | |

As shown in Table 9, the HO-RSP message includes a plurality of IEs, i.e., the N_Recommended of the HO-REQ message and information for the candidate sponsor nodes included in the N_Recommended. According to the information for the candidate sponsor nodes included in the N_Recommended, the candidate sponsor nodes are arranged in such a manner that a candidate sponsor node most proper for the handover of the MSS is located before the others. In arranging the candidate sponsor nodes, a candidate sponsor node having a higher expected data rate is located before the others under an assumption that a bandwidth and a Quality of Service (QoS) level required by the MSS are satisfied. Because the process for calculating the expected data rate is to be described in detail later, the detailed description will be omitted here.

The information for the candidate sponsor nodes includes the candidate sponsor ID representing the identifier of the candidate sponsor node and the Candidate Sponsor Serving BS ID representing the serving BS identifier of the candidate sponsor node. When the candidate sponsor node is the MSS, the Candidate Sponsor Serving BS ID field includes the serving BS identifier. However, when the candidate sponsor node is the BS, the Candidate Sponsor Serving BS ID field does not include a separate value.

After receiving the HO-RSP message from the BS 300, the MSS 310 transmits a HandOver Indication (HO-IND) message, which indicates the MSS 310 is to be handed over to the MSS 320, to the BS 300 in step 425). The HO-IND message is a message newly proposed by the present invention, which has a structure as shown in Table 10 below.

TABLE 10

| Syntax | Notes |
|---|---|
| HO-IND_message_Format( ){ | |
| HO-IND_type | 00: Serving BS release |
| | 01˜11: reserved |
| Target Sponsor ID | |
| Target Sponsor's Serving BS ID (if | When Target sponsor node is BS, this |
| exists) | field is empty. |
| | When Target sponsor node is MSS, |
| | serving BS ID of corresponding MSS |
| | is written. |
| } | |

As shown in Table 10, the HO-IND message includes a plurality of IEs, i.e., the HO-IND_type representing the types of the HO-IND message, the Target Sponsor ID representing the identifier of the sponsor node finally selected by the MSS, and the Target Sponsor's Serving BS ID representing the identifier of the Serving BS of the MSS when the finally selected sponsor node is the MSS.

The BS 300 having received the HO-IND message from the MSS 310 ends the direct communication with the MSS 310 in step 427.

If the MSS 310 has selected the MSS 320 as the new serving node, the MSS 310 must perform a network entry operation with the MSS 320. Because a message exchange process (i.e., steps 429, 431, 433, and 435) for the network entry operation is identical to the processes of steps 411, 413, 415, and 417, the detailed description will be omitted here.

In the handover operation process illustrated in FIG. 4, because the BS 300 has already understood information relating to an authentication, a registration, an IP connection setup, etc., for the MSS 310, the MSS 310 does not need to separately perform the authentication, the registration, and the IP connection setup for the MSS 320.

In FIG. 4, when the MSS is to be handed over, the message including the information for a plurality of candidate sponsor nodes is transmitted, such that the current serving sponsor node selects one of the candidate sponsor nodes as the final target sponsor node, and enables the MSS to be handed over to the final target sponsor node. However, it will is apparent to those skilled in the art that the MSS may directly select the final target sponsor node.

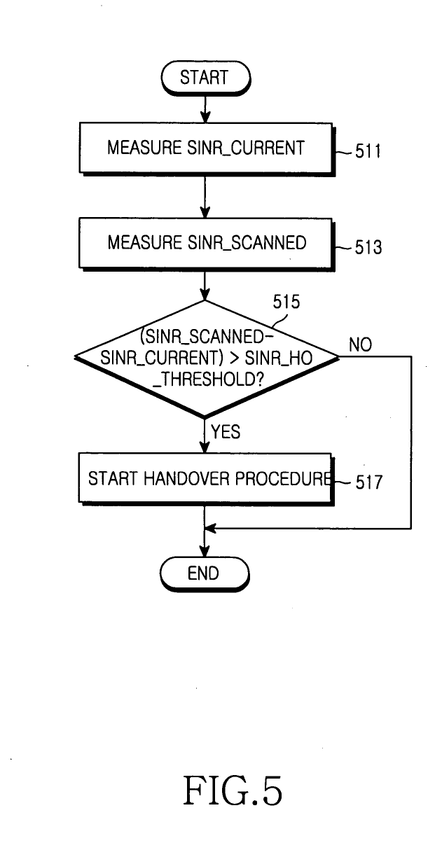

FIG. 5 is a flow diagram illustrating the scanning and handover determination operation process, i.e., step 419 of FIG. 4. Referring to FIG. 5, in step 511, the MSS 310 measures the SINR (SINR_CURRENT) of the signal received from the serving sponsor node, i.e., the BS 300, to which the MSS 310 currently belongs. In step 513, the MSS 310 measures the SINR (SINR_SCANNED) of the candidate sponsor nodes. In step 515, the MSS 310 determines if a value obtained by subtracting the SINR_CURRENT from the SINR_SCANNED exceeds a preset SINR_HO_THRESHOLD. The SINR_HO_THRESHOLD represents a minimum value of difference between the SINR_CURRENT and the SINR_SCANNED, which is used for determining whether to perform the handover. When the value is larger than the SINR_HO_THRESHOLD, the MSS 310 determines to be handed over from the current serving sponsor node, i.e., the BS 300, to another node, and starts the handover procedure to the candidate sponsor node, i.e., the MSS 320, in step 517.

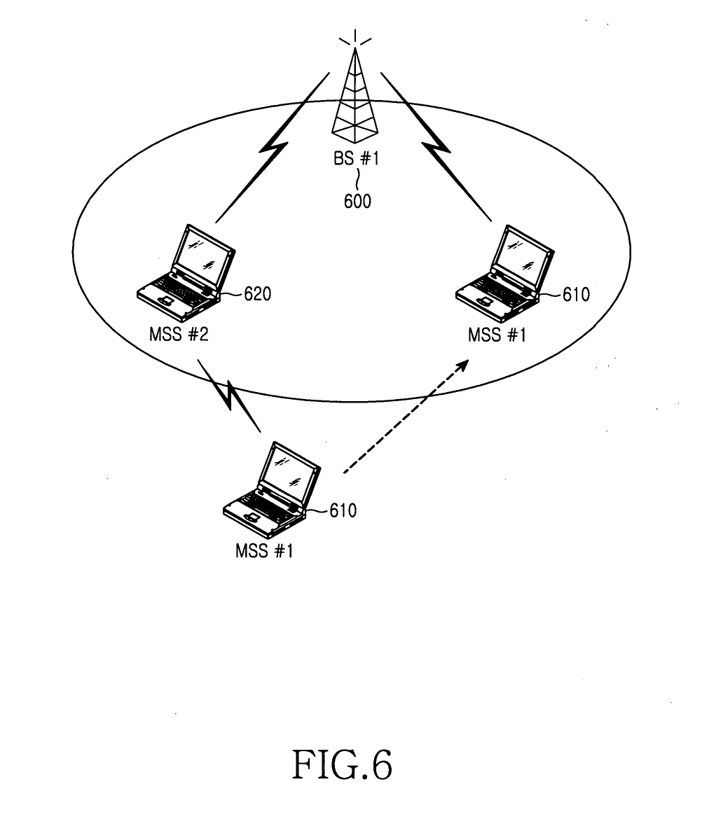

FIG. 6 illustrates an MSS in mesh communication performing the intra-cell handover {intra-cell Mesh-to-Direct (M2D) handover} for direct communication with a BS in the mesh IEEE 802.16e communication system. More specifically, FIG. 6 is a diagram schematically illustrating the intra-cell M2D handover operation in the mesh IEEE 802.16e communication system according to a second embodiment of the present invention.

Referring to FIG. 6, an MSS 610 performs the mesh communication after being connected to a BS 600 through an MSS 620. Accordingly, an MSS 620 is a serving sponsor node of the MSS 610 and the BS 600 becomes a new serving sponsor node of the MSS 610 when the MSS 610 performs direct communication with the BS 600. As illustrated in FIG. 6, because the sponsor node of the MSS 610 changes and the BS 600 does not change, the intra-cell M2D handover becomes the intra-cell handover.

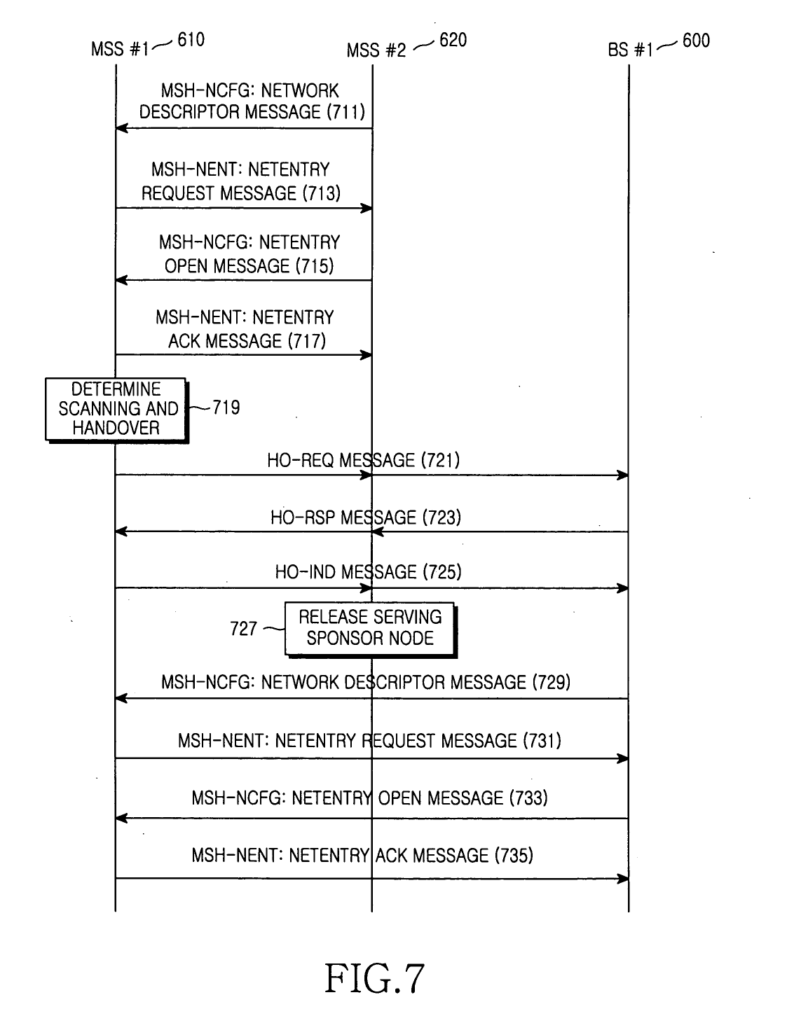

FIG. 7 is a flow diagram illustrating the intra-cell M2D handover process in the mesh IEEE 802.16e communication system according to the second embodiment of the present invention. Referring to FIG. 7, because the MSS 610 performs the mesh communication with the MSS 620 as illustrated in FIG. 6, the MSS 610 performs a network entry operation with the MSS 620 and performs a scanning and handover determination operation during the mesh communication with the MSS 620. Because steps 711, 713, 715, 717, and 719 are identical to steps 411, 413, 415, 417, and 419 as illustrated in FIG. 4, the detailed description will be omitted here.

After the MSS 610 determines the handover, the MSS 610 transmits an HO-REQ message for requesting the handover from the current serving sponsor node, i.e., the MSS 620, to another sponsor node to a BS 600 through the MSS 620 in step 721. The HO-REQ message is transferred to the BS 600 instead of being directly processed by the MSS 620 in order to simplify an operation of the MSS without providing the same role (e.g., target sponsor node selection role) as that performed by a serving BS to each MSS. The HO-REQ message includes information for candidate sponsor nodes to which the MSS 610 can be handed over.

After receiving the HO-REQ message from the MSS 610, the BS 600 recognizes the intra-cell M2D handover of the MSS 610 and determines a target sponsor node to which the MSS 610 is to be handed over. Then BS 600 inserts information for the determined target sponsor node into an HO-RSP message for the HO-REQ message, and transmits the HO-RSP message to the MSS 610 through the MSS 620 in step 723.

In FIG. 7, it is assumed that the MSS 610 has been determined to be handed over to the BS 600. The MSS 610 having received the HO-RSP message transmits an HO-IND message, which indicates the MSS 610 is to be handed over to the BS 600, to the BS 600 through the MSS 620 in step 725. The MSS 620, having received the HO-IND message, releases the serving sponsor node operation for the MSS 610 in step 727.

The MSS 610, having changed the serving sponsor node to the BS 600, performs a network entry operation with the BS 600. Because operations of steps 729, 731, 733, and 735 are identical to steps 429, 431, 433, and 435 as illustrated in FIG. 4, the detailed description will be omitted here.

In the handover operation process illustrated in FIG. 7, because the BS 600 has already understood information relating to an authentication, a registration, an IP connection setup, etc., for the MSS 610, the MSS 610 does not need to separately perform the authentication, the registration, and the IP connection setup for the BS 600.

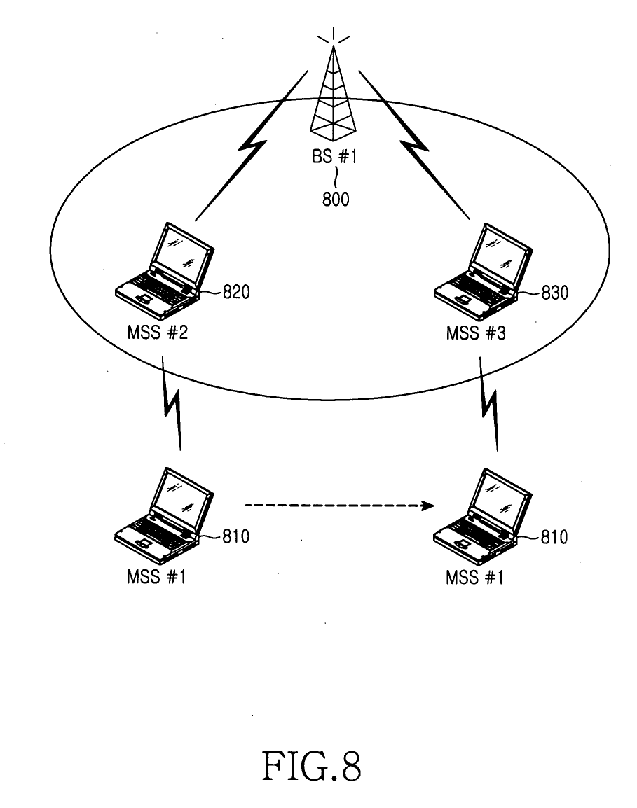

FIG. 8 illustrates an MSS in mesh communication performing the intra-cell handover {intra-cell Mesh-to-Mesh (M2M) handover} for mesh communication with a different sponsor node in the mesh IEEE 802.16e communication system. More specifically, FIG. 8 is a diagram schematically illustrating the intra-cell M2M handover operation in the mesh IEEE 802.16e communication system according to a third embodiment of the present invention.

Referring to FIG. 8, an MSS 810 performs mesh communication with a BS 800, i.e., a serving BS, using an MSS 820 as a serving sponsor node. The MSS 810 moves while performing the mesh communication through the MSS 820, and selects an MSS 830 as a new serving sponsor node, i.e., a target sponsor node. Accordingly, the MSS 810 performs mesh communication with the BS 800 through the MSS 830. As a result, because the sponsor node of the MSS 810 changes and the BS 800 does not change, the intra-cell M2M handover also becomes the intra-cell handover.

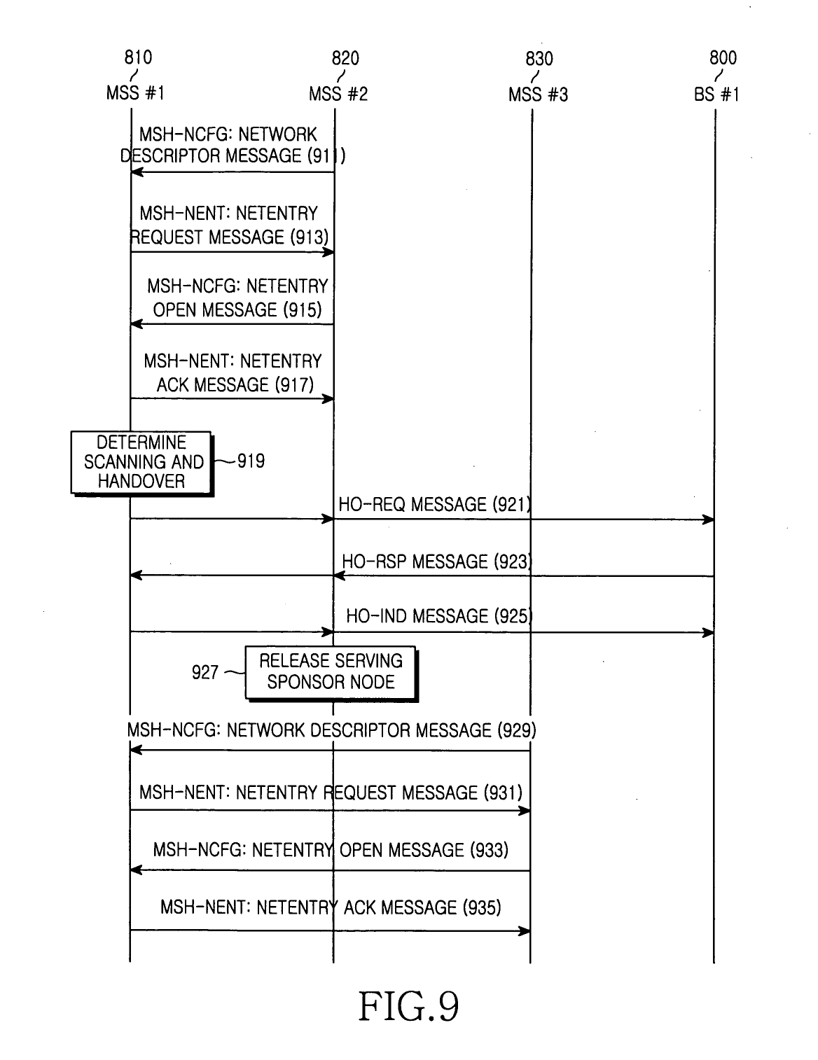

FIG. 9 is a flow diagram illustrating the intra-cell M2M handover process in the mesh IEEE 802.16e communication system according to the third embodiment of the present invention. Referring to FIG. 9, because the MSS 810 performs the mesh communication with the MSS 820 as illustrated in FIG. 8, the MSS 810 performs a network entry operation with the MSS 820 and performs a scanning and handover determination operation during the mesh communication with the MSS 820. Because steps 911, 913, 915, 917, and 919 are identical to steps 411, 413, 415, 417, and 419 as illustrated in FIG. 4, the detailed description will be omitted here.

After the MSS 810 determines the handover from the current serving sponsor node, i.e., the MSS 820 to another sponsor node, the MSS 810 transmits an HO-REQ message to a BS 800, which is the serving BS of the MSS 820, through the MSS 820 in step 921. The HO-REQ message is transferred to the BS 800 instead of being directly processed by the MSS 820 is in order to simplify an operation of the MSS without providing the same role (e.g., target sponsor node selection role) as that performed by a serving BS to each MSS. The HO-REQ message includes information for candidate sponsor nodes to which the MSS 810 can be handed over.

After receiving the HO-REQ message from the MSS 810, the BS 800 recognizes the intra-cell M2M handover of the MSS 810 and determines a target sponsor node to which the MSS 810 is to be handed over. The BS 800 transmits an HO-RSP message for the HO-REQ message to the MSS 810 through the MSS 820 in step 923.

In FIG. 9, it is assumed that the MSS 810 has been determined to be handed over to the MSS 830 as illustrated in FIG. 8. The MSS 810 having received the HO-RSP message transmits an HO-IND message, which indicates the MSS 810 is to be handed over to the MSS 830, to the BS 800 through the MSS 820 in step 925. The MSS 820 having received the HO-IND message releases the serving sponsor node operation for the MSS 810 in step 927.

The MSS 810, having changed the serving sponsor node to the MSS 830, performs a network entry operation with the MSS 830. Because steps 929, 931, 933, and 935 are identical to steps 429, 431, 433, and 435 as illustrated in FIG. 4, the detailed description will be omitted here.

In the handover operation process illustrated in FIG. 9, because the BS 800 has already understood information relating to an authentication, a registration, an IP connection setup, etc., for the MSS 810, the MSS 810 does not need to separately perform the authentication, the registration, and the IP connection setup for the MSS 830.

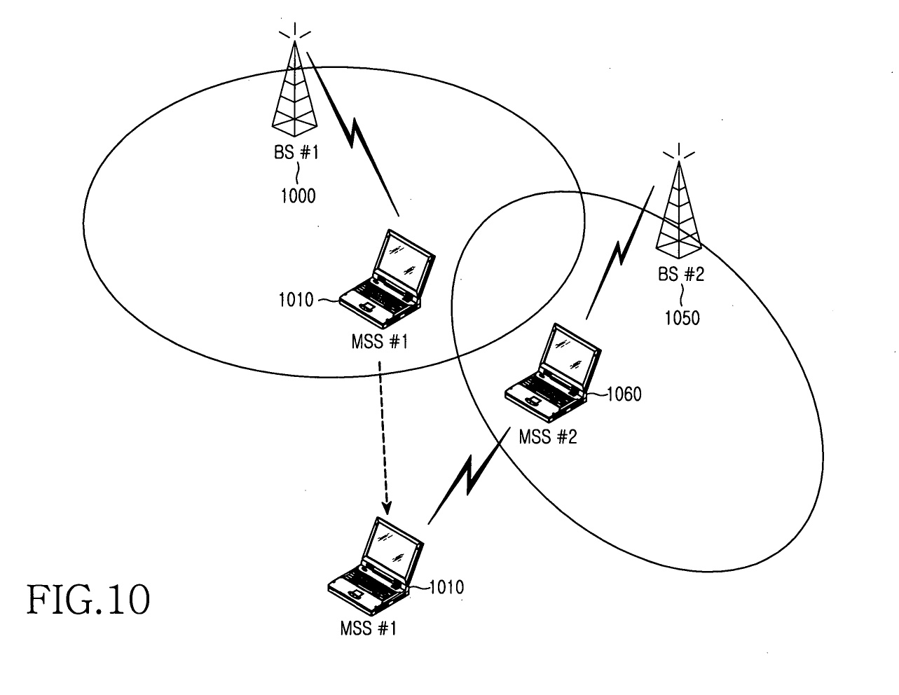

FIG. 10 illustrates an MSS in direct communication moving to a cell controlled by a BS different from a serving BS to which the MSS currently belongs and performing the inter-cell handover {inter-cell Direct-to-Mesh (D2M) handover} for mesh communication with an MSS belonging to the different BS in the mesh IEEE 802.16e communication system. More specifically, FIG. 10 is a diagram schematically illustrating the inter-cell D2M handover operation in the mesh IEEE 802.16e communication system according to a fourth embodiment of the present invention.

Referring to FIG. 10, an MSS 1010 moves from a BS 1000 to another BS 1050 during direct communication with the BS 1000 (serving BS), selects an MSS 1060 as a new sponsor node, and performs mesh communication with the BS 1050 through the MSS 1060. As illustrated in FIG. 10, because the serving BS of the MSS 1010 changes from the BS 1000 to the BS 1050, the inter-cell D2M handover becomes the inter-cell handover.

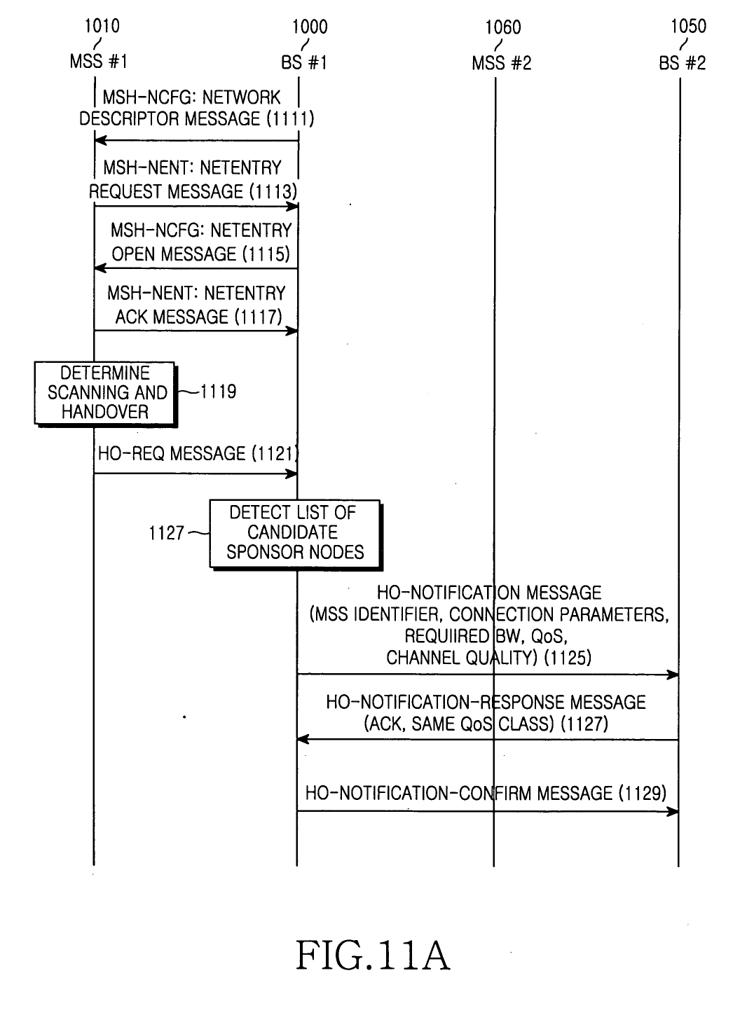

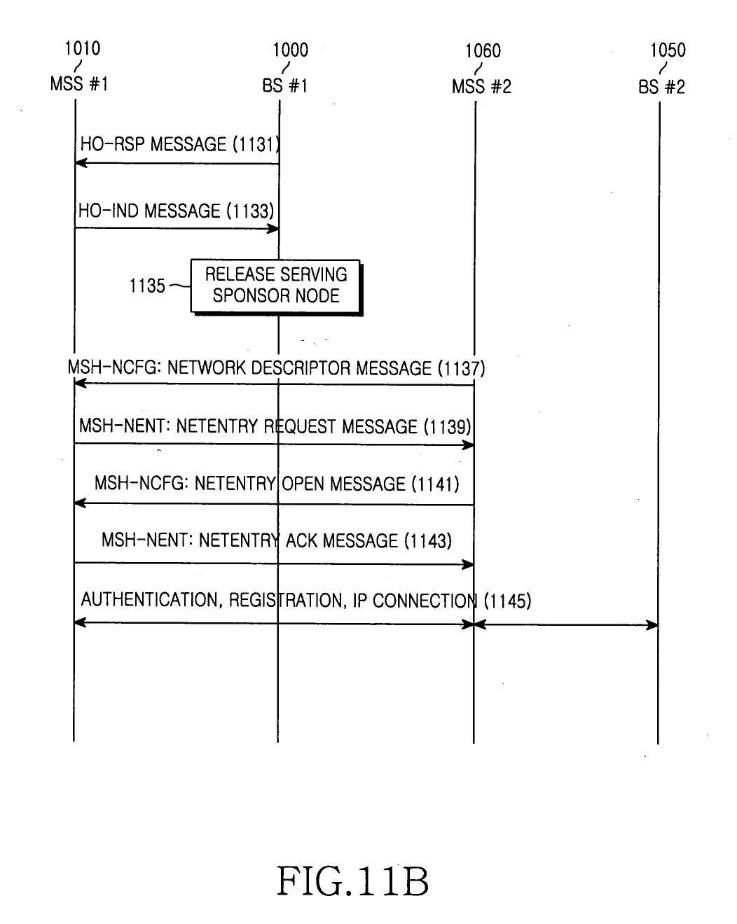

FIGS. 11A and 11B are flow diagrams illustrating the inter-cell D2M handover process in the mesh IEEE 802.16e communication system according to the fourth embodiment of the present invention. Referring to FIGS. 11A and 11B, because the MSS 1010 performs the direct communication with the BS 1000 as illustrated in FIG. 10, the MSS 1010 performs a network entry operation with the BS 1000 and performs a scanning and handover determination operation during the direct communication with the BS 1000. Because steps 1111, 1113, 1115, 1117, and 1119 are identical to steps 411, 413, 415, 417, and 419 as illustrated in FIG. 4, the detailed description will be omitted here.

After the MSS 1010 determines to be handed over to the MSS 1060 in step 1119, the MSS 1010 transmits an HO-REQ message to the BS 1000, which is the current serving sponsor node and serving BS, in step 1121. The HO-REQ message includes information for candidate sponsor nodes to which the MSS 1010 can be handed over as described above. Accordingly, the BS 1000 detects a list of the candidate sponsor nodes and selects a target sponsor node to which the MSS 1010 is to be handed over from the list in step 1123.

Because the MSS 1010 has determined to be handed over to the MSS 1060, the BS 1000 transmits a handover notification (HO-NOTIFICATION) message to the BS 1050, which is a serving BS, including the MSS 1060 in step 1125. The HO-NOTIFICATION message includes information for an identifier (MSS identifier), a required bandwidth, QoS and channel quality of the MSS 1010, and a connection parameter. The HO-NOTIFICATION message is a message newly proposed by the present invention, which has a structure as shown in Table 11 below.

TABLE 11

| Syntax | Notes |
|---|---|
| Global Header | |
| For (j=0; j<Num Records; j++) | |
| MSS unique identifier | |
| Target Sponsor ID (if not BS) | When Target Sponsor is BS, this field |
| | is empty. |
| | When Target sponsor node is MSS, |
| | serving BS ID of corresponding MSS is |
| | written. |
| Required Data Rate | Required data rate |
| Required Bandwidth | Required bandwidth |
| Required QoS | Required QoS condition |
| } | |
| Security Field | |
| CRC Field | |

After receiving the HO-NOTIFICATION message from the BS 1000, the BS 1050 transmits a handover notification response (HO-NOTIFICATION-RESPONSE) message to the BS 1000 in response to the HO-NOTIFICATION message in step 1127. The HO-NOTIFICATION-RESPONSE message includes Ack information representing whether the handover of the MSS 1010 is possible, and receivable QoS information when the MSS 1010 is handed over to the MSS 1060. The HO-NOTIFICATION-RESPONSE message is a message newly proposed by the present invention, which has a structure as shown in Table 12 below.

TABLE 12

| Syntax | Notes |
|---|---|
| Global Header | |
| For (j=0; j<Num Records; j++) | |
| MSS unique identifier | |
| Target Sponsor ID (if not BS) | When Target Sponsor is BS, this field |
| | is empty. |
| | When Target sponsor node is MSS, |
| | serving BS ID of corresponding MSS is |
| | written. |
| Data Rate Estimated | Estimated data rate |
| Bandwidth Estimated | Estimated bandwidth |
| QoS Estimated | Estimated QoS condition |
| ACK/NACK | ACK represents neighbor BS accepts |
| | handover. NACK represents it may be |
| | impossible to accept handover. |
| } | |
| Security Field | |
| CRC Field | |

After receiving the HO-NOTIFICATION-RESPONSE message, the BS 1000 transmits a handover notification confirmation (HO-NOTIFICATION-CONFIRM) message to the BS 1050 in step 1129. The HO-NOTIFICATION-CONFIRM message is a message newly proposed by the present invention, which has a structure as shown in Table 13 below.

TABLE 13

| Syntax | Notes |
|---|---|
| Global Header | |
| For (j=0; j<Num Records; j++) | |
| MSS unique identifier | |
| Target Sponsor ID (if not BS) | When Target Sponsor is BS, this field |
| | is empty. |
| | When Target sponsor node is MSS, |
| | serving BS ID of corresponding MSS is |
| | written. |
| Data Rate Estimated | Estimated data rate |
| Bandwidth Estimated | Estimated bandwidth |
| QoS Estimated | Estimated QoS condition |
| } | |
| Security Field | |
| CRC Field | |

Further, the BS 1000 transmits an HO-RSP message to the MSS 1010, which is a response message for the HO-REQ message in step 1131.

After receiving the HO-RSP message from the BS 1000, the MSS 1010 transmits an HO-IND message representing the MSS 1010 is to be handed over to the MSS 1060 to the BS 1000 in step 1133. After receiving the HO-IND message from the MSS 1010, the BS 1000 releases the operation as the serving sponsor node for the MSS 1010 in step 1135.

The MSS 1010 performs a network entry operation with the MSS 1060, i.e., performs steps 1137, 1139, 1141, and 1143, and sets a mesh connection through the MSS 1060. Because steps 1137, 1139, 1141, and 1143 are identical to steps 429, 431, 433, and 435 in FIG. 4, the detailed description will be omitted here.

In the handover operation process illustrated in FIGS. 11A and 11B, because the BS 1050 has not understood information relating to an authentication, a registration, an IP connection setup, etc., for the MSS 1010, the MSS 1010 performs an operation such as the authentication, the registration, and the IP connection for the BS 1050 through the MSS 1060 in step 1145. Herein, because the operation such as the authentication, the registration, and the IP connection has no direct connection with the subject matter of the present invention, the detailed description will be omitted.

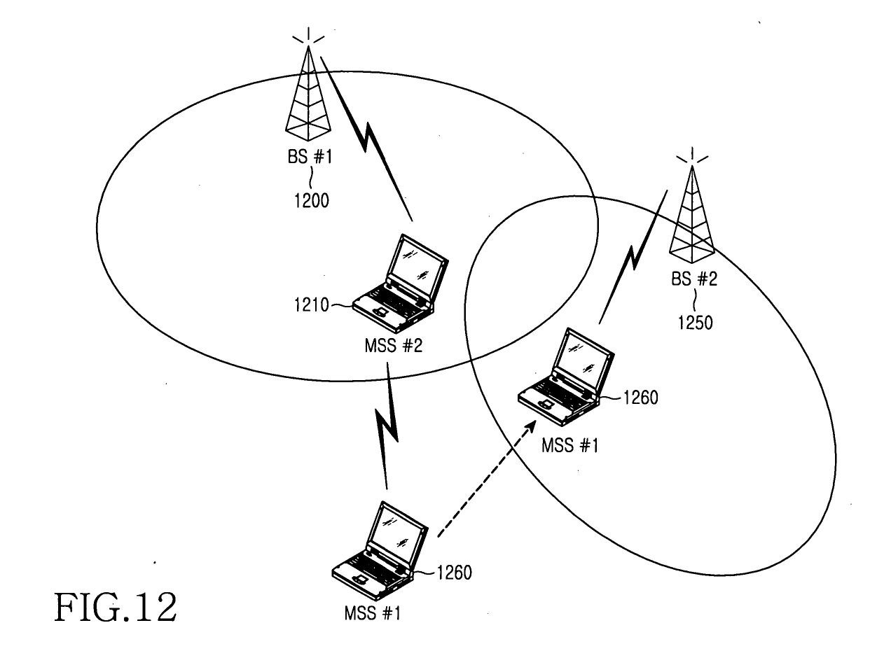

FIG. 12 illustrates an MSS in mesh communication moving to a cell controlled by a different BS and performing direct communication {inter-cell Mesh-to-Direct (M2D) handover} with the different BS in the mesh IEEE 802.16e communication system. More specifically, FIG. 12 is a diagram schematically illustrating the inter-cell M2D handover operation in the mesh IEEE 802.16e communication system according to a fifth embodiment of the present invention.

Referring to FIG. 12, an MSS 1260 moves to a cell controlled by a BS 1250 during mesh communication with the BS 1200 (serving BS) through an MSS 1210 (serving sponsor node), and performs direct communication with the BS 1250. As illustrated in FIG. 12, because the serving BS of the MSS 1260 changes from the BS 1200 to the BS 1250, the inter-cell M2D handover becomes the inter-cell handover.

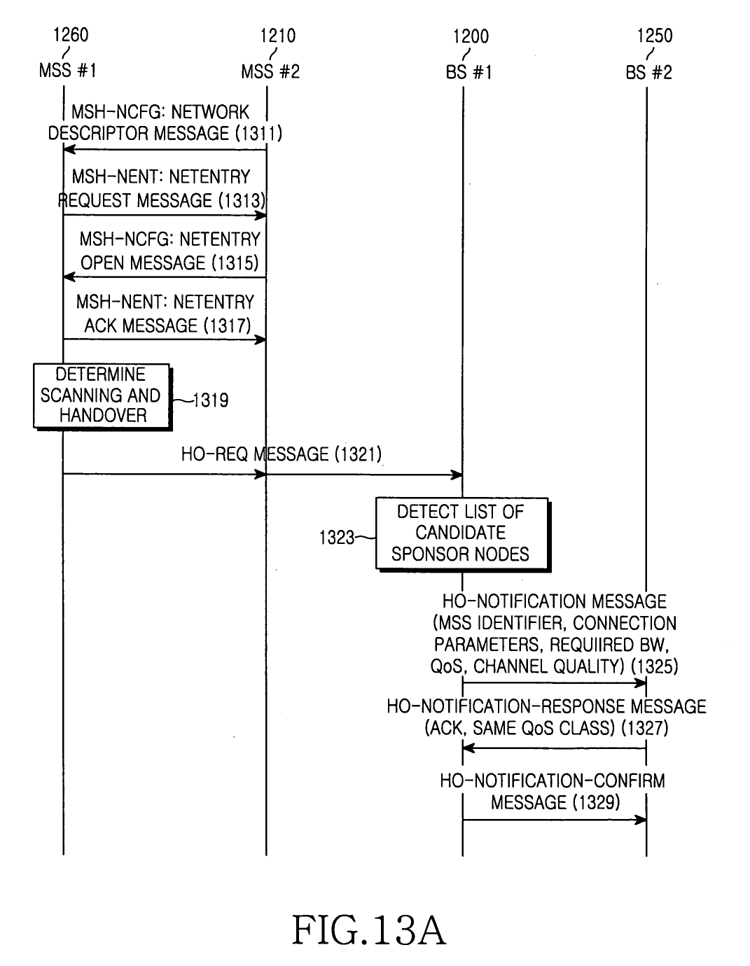

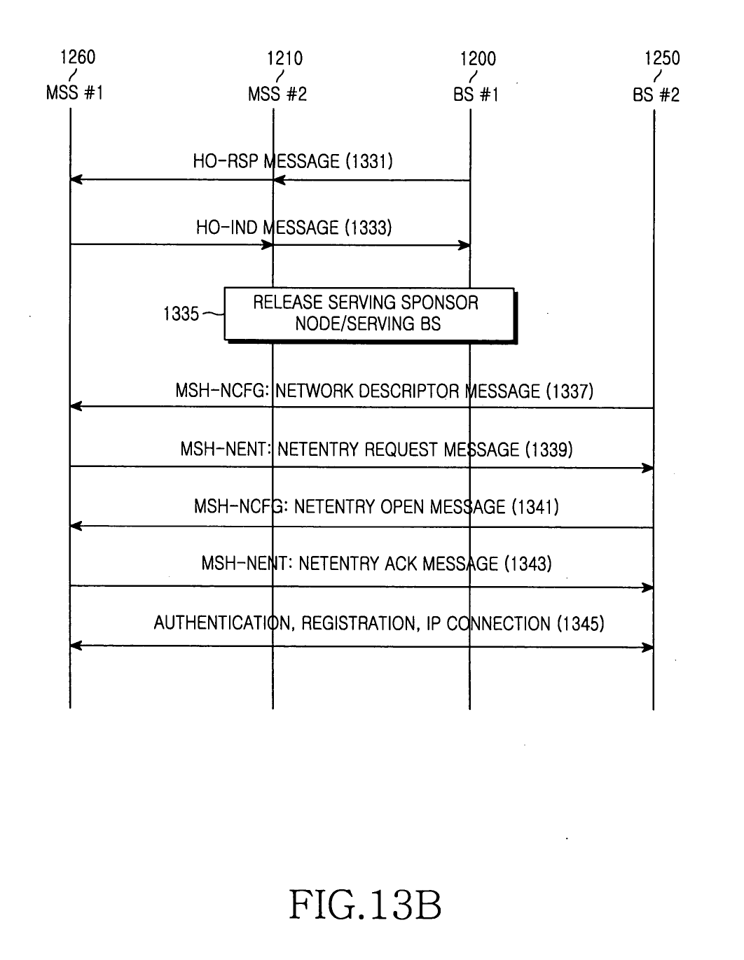

FIGS. 13A and 13B are flow diagrams illustrating the inter-cell M2D handover process in the mesh IEEE 802.16e communication system according to the fifth embodiment of the present invention. Referring to FIGS. 13A and 13B, because the MSS 1260 performs the mesh communication with the BS 1200 through the MSS 1210 as illustrated in FIG. 12, the MSS 1260 performs a network entry operation with the MSS 1210 and performs a scanning and handover determination operation during the mesh communication with the MSS 1210. Because steps 1311, 1313, 1315, 1317, and 1319 are identical to steps 411, 413, 415, 417, and 419 as illustrated in FIG. 4, the detailed description will be omitted here.

After determining the handover in step 1319, the MSS 1260 transmits an HO-REQ message to the BS 1200 (serving BS) through the MSS 1210 (current serving sponsor node) in step 1321. As described above, the MSS 1260 can transmit the HO-REQ message including information for multiple candidate sponsor nodes to which the MSS 1260 can be handed over. In this case, the BS 1200 detects a list of the candidate sponsor nodes and selects a target sponsor node to which the MSS 1260 is to be handed over from the list in step 1323.

Because the MSS 1260 has determined to be handed over to the BS 1250, the BS 1200 performs operations representing the MSS 1260 is to be handed over to the BS 1250, i.e., steps 1325, 1327, 1329, 1331, and 1333. Because steps 1325, 1327, 1329, 1331, and 1333 are identical to steps 1125, 1127, 1129, 1131, and 1133, the detailed description will be omitted here. However, it is noted that the HO-RSP message of step 1331 and the HO-IND message of step 1333 are transferred through the MSS 1210, in contrast with the HO-RSP message of step 1131 and the HO-IND message of step 1133.

After the MSS 1210 and the BS 1200 receive the HO-IND message from the MSS 1260, the MSS 1210 and the BS 1200 release the serving sponsor node operation and the serving BS operation in step 1335. The MSS 1260 performs a network entry operation with the BS 1250, and an operation such as an authentication, a registration, and an IP connection, i.e., steps 1337, 1339, 1341, 1343, and 1345. Because steps 1337, 1339, 1341, 1343, and 1345 are identical to steps 1137, 1139, 1141, 1143, and 1145 as illustrated in FIGS. 11A and 11B, the detailed description will be omitted here.

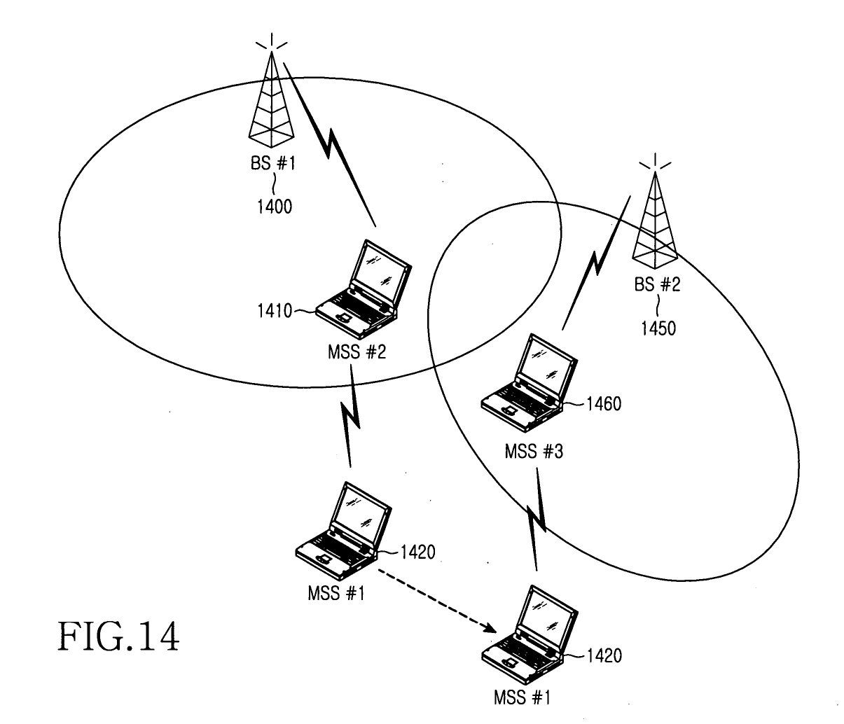

FIG. 14 illustrates an MSS in mesh communication moving to a cell controlled by a different BS, selecting a serving sponsor node in the cell, and performing mesh communication {inter-cell Mesh-to-Mesh (M2M) handover} with the different BS through the serving sponsor node in the mesh IEEE 802.16e communication system. More specifically, FIG. 14 is a diagram schematically illustrating the inter-cell M2M handover operation in the mesh IEEE 802.16e communication system according to a sixth embodiment of the present invention.

Referring to FIG. 14, an MSS 1420 moves to a cell controlled by a BS 1450 during mesh communication with the BS 1400 (serving BS) through an MSS 1410 (serving sponsor node), and performs mesh communication with the MSS 1460. As illustrated in FIG. 14, because the serving BS of the MSS 1420 changes from the BS 1400 to the BS 1450, the inter-cell M2M handover becomes the inter-cell handover.

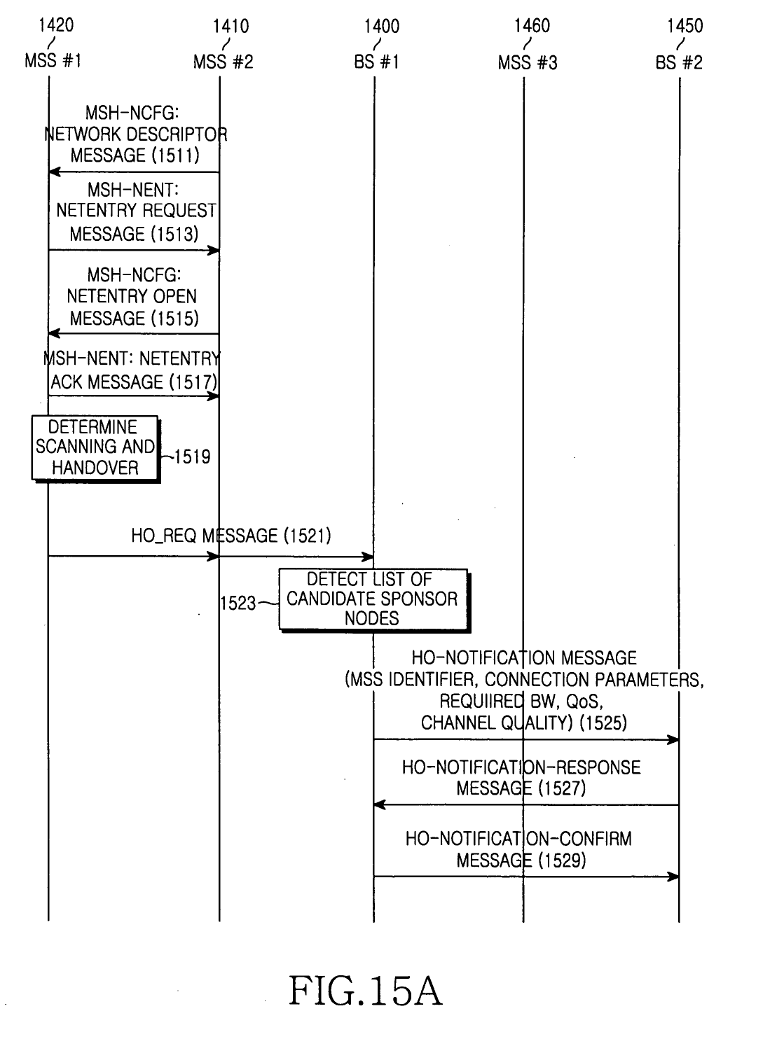

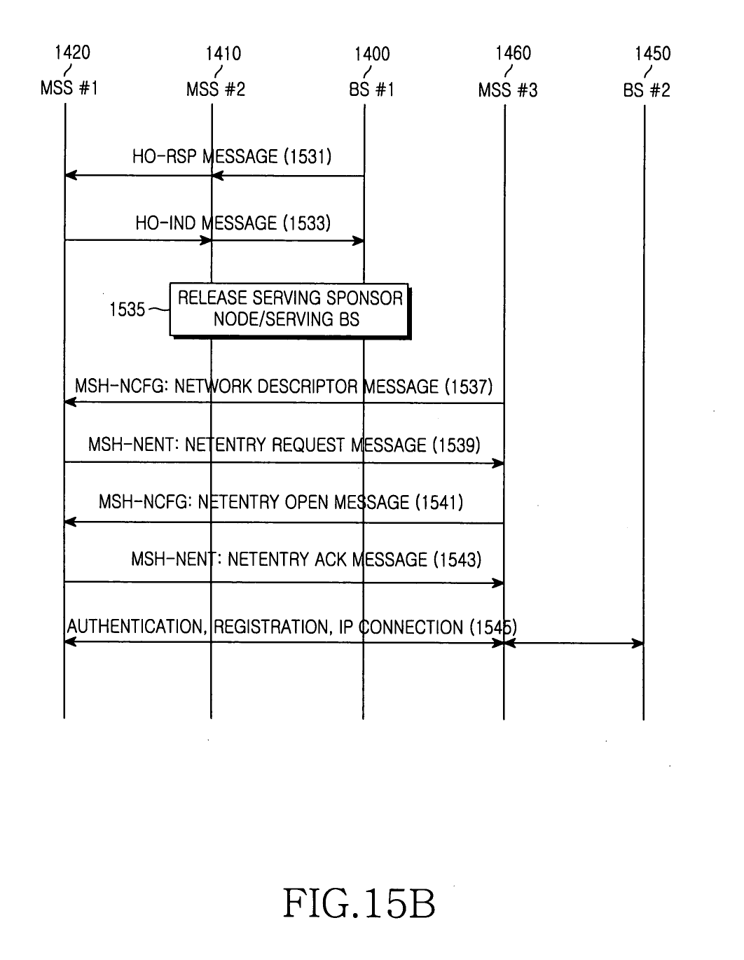

FIGS. 15A and 15B are flow diagrams illustrating the inter-cell M2M handover process in the mesh IEEE 802.16e communication system according to the sixth embodiment of the present invention. Referring to FIGS. 15A and 15B, because the MSS 1420 performs the mesh communication through the MSS 1410 as illustrated in FIG. 14, the MSS 1420 performs a network entry operation with the MSS 1410 and performs a scanning and handover determination operation during the mesh communication with the MSS 1410. Because steps 1511, 1513, 1515, 1517, and 1519 are identical to steps 411, 413, 415, 417, and 419 as illustrated in FIG. 4, the detailed description will be omitted here.

After determining the handover in step 1519, the MSS 1420 transmits an HO-REQ message to the BS 1400 (serving BS) through the MSS 1410 (current serving sponsor node) in step 1521. As described above, the MSS 1420 can transmit the HO-REQ message including information for multiple candidate sponsor nodes to which the MSS 1420 can be handed over. In this case, the BS 1400 detects a list of the candidate sponsor nodes and selects a target sponsor node to which the MSS 1420 is to be handed over from the list in step 1523.

Because the MSS 1420 has determined to be handed over to the MSS 1460, the BS 1400 performs operations representing the MSS 1420 is to be handed over to the MSS 1460, i.e., steps 1525, 1527, 1529, 1531, and 1533. Because steps 1525, 1527, 1529, 1531, and 1533 are identical to steps 1325, 1327, 1329, 1331, and 1333 as illustrated in FIGS. 13A and 13B, the detailed description will be omitted here.

After the MSS 1410 and the BS 1400 receive the HO-IND message from the MSS 1420, the MSS 1410 and the BS 1400 release the serving sponsor node operation and the serving BS operation in step 1535. The MSS 1420 performs a network entry operation with the MSS 1460, and an operation such as an authentication, a registration, and an IP connection, i.e., steps 1537, 1539, 1541, 1543, and 1545. Because steps 1537, 1539, 1541, 1543, and 1545 are identical to steps 1137, 1139, 1141, 1143, and 1145 as illustrated in FIGS. 11A and 11B, the detailed description will be omitted here.

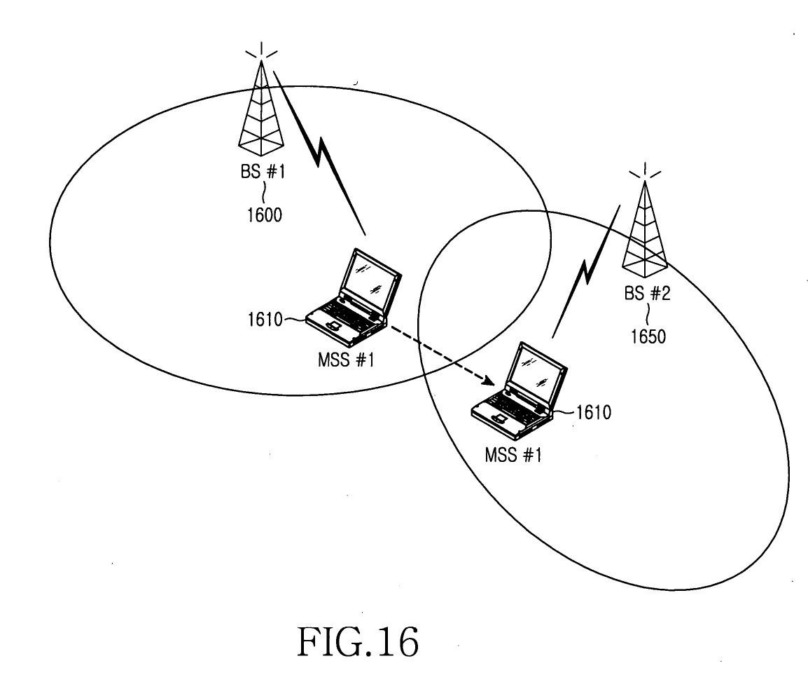

FIG. 16 illustrates an MSS in direct communication moving to a cell controlled by a different BS, and performing direct communication {inter-cell Direct-to-Direct (D2D) handover} with the different BS in the mesh IEEE 802.16e communication system. More specifically, FIG. 16 is a diagram schematically illustrating the inter-cell D2D handover operation in the mesh IEEE 802.16e communication system according to a seventh embodiment of the present invention.

Referring to FIG. 16, an MSS 1610 moves to a cell controlled by a BS 1650 during direct communication with the BS 1600 (serving BS), and performs direct communication with the BS 1650. As illustrated in FIG. 16, because the serving BS of the MSS 1610 changes from the BS 1600 to the BS 1650, the inter-cell D2D handover becomes the inter-cell handover.

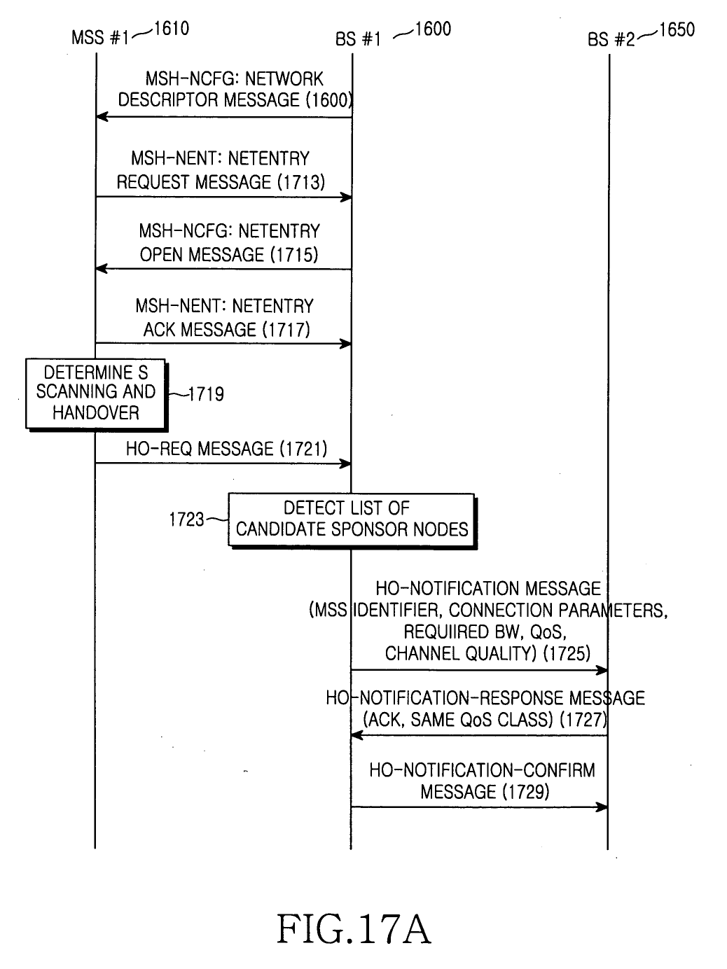

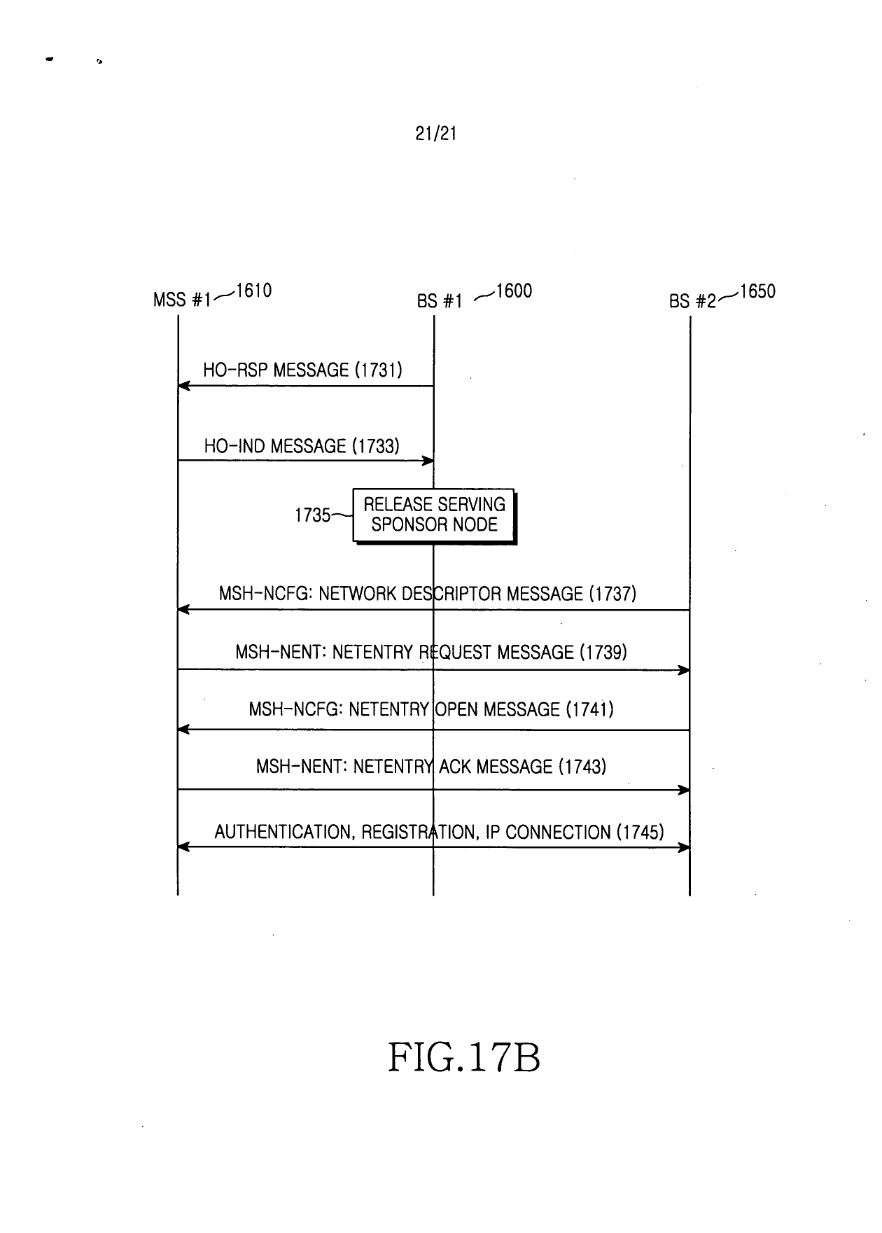

FIGS. 17A and 17B are flow diagrams illustrating the inter-cell D2D handover process in the mesh IEEE 802.16e communication system according to the seventh embodiment of the present invention. Referring to FIGS. 17A and 17B, because the MSS 1610 performs the direct communication with the BS 1600 as illustrated in FIG. 16, the MSS 1610 performs a network entry operation with the BS 1600 and performs a scanning and handover determination operation during the direct communication with the BS 1600. Because steps 1711, 1713, 1715, 1717, and 1719 are identical to steps 411, 413, 415, 417, and 419 as illustrated in FIG. 4, the detailed description will be omitted here.

After determining the handover in step 1719, the MSS 1610 transmits an HO-REQ message to the BS 1600, which is a current serving sponsor node and serving BS, in step 1721. As described above, the MSS 1610 can transmit the HO-REQ message including information for multiple candidate sponsor nodes to which the MSS 1610 can be handed over. In this case, the BS 1600 detects a list of the candidate sponsor nodes and selects a target sponsor node to which the MSS 1610 is to be handed over from the list in step 1723.

Because the MSS 1610 has determined to be handed over to the BS 1650, the BS 1600 performs operations representing the MSS 1610 is to be handed over to the BS 1650, i.e., steps 1725, 1727, 1729, 1731, and 1733. Because steps 1725, 1727, 1729, 1731, and 1733 are identical to steps 1125, 1127, 1129, 1131, and 1133 as illustrated in FIGS. 11A and 11B, the detailed description will be omitted here.

After the BS 1600 receive the HO-IND message from the MSS 1610, the BS 1600 release the serving BS operation in step 1735. The MSS 1610 performs a network entry operation with the BS 1650, and an operation such as an authentication, a registration, and an IP connection, i.e., steps 1737, 1739, 1741, 1743, and 1745. Because steps 1737, 1739, 1741, 1743, and 1745 are identical to steps 1137, 1139, 1141, 1143, and 1145 as illustrated in FIGS. 11A and 11B, the detailed description will be omitted here.

In the first to the seventh embodiment of the present invention, a scheme for determining the target sponsor node from among the candidate sponsor nodes is as follows.

The HO-NOTIFICATION message transmitted from the serving BS to the target BS in which the target sponsor node exists includes Channel Quality Information (CQI) between the MSS intended for handover and the target sponsor node. The target BS determines if it is possible to meet the QoS required by the MSS intended for handover through the channel quality information. Further, the target BS measures the channel quality to calculate the available data rate, and determines if it is possible to meet the bandwidth required by the MSS.

The data rate is calculated by the following two schemes.

In the first scheme, when the target sponsor node to which the MSS is to be handed over is a BS, i.e., when the target sponsor node is the BS regardless of a serving BS or a target BS, the target BS measures the channel quality between the MSS and the target BS or the serving BS, and calculates the data rate.

In the second scheme, when the target sponsor node to which the MSS is to be handed over is a different MSS, it is assumed that the different MSS (an MSSᵢ₋₁), which becomes the target sponsor node, and the target BS (serving BS in an intra-cell handover) are spaced apart from each other by an (n−1) hop. As a result, the MSS (MSSᵢ) intended for handover and the target BS (serving BS in an intra-cell handover) are spaced apart from each other by an n hop. In this case, when a data rate based on the channel quality between the target BS (serving BS in the intra-cell handover) and the MSSᵢ is DR_{BS-MSSi}, a data rate based on the channel quality between the MSSᵢ₋₁ and the MSSᵢ is DR_{MSS(i-1-MSSi}, an estimated data rate can be calculated as shown in Equation (1).

$$DataRate = \frac{{\sum }_{i = 1}^{n} {DR}_{MSS ( i - 1 ) - MSSi}}{n} , {MSS}_{o} = BS \qquad ( 1 )$$

The estimated data rate calculated in Equation (1) is transmitted to the serving BS through the HO-NOTIFICATION-RESPONSE message. The serving BS determines if a candidate target BS (serving BS in the intra-cell handover) can meet the bandwidth required by the MSS intended for the handover according to the estimated data rate. The serving BS selects the optimal target BS (serving BS in the intra-cell handover), inserts information for the selected target BS into the HO-RSP message, and transmits the HO-RSP message to the MSS intended for the handover.

As described above, the present invention applies a mesh mode in a BWA communication system, i.e., an IEEE 802.16e communication system, which uses an OFDM/OFDMA scheme, so that handover can be performed in the mesh mode. Accordingly, in the mesh of the IEEE 802.16e communication system, it is possible to ensure an MSS mobility as well as high transmission speed.

While the present invention has been shown and described with reference to certain preferred embodiments thereof, it will be understood by those skilled in the art that various changes in form and details may be made therein without departing from the spirit and scope of the present invention as defined by the appended claims.

1. A method for handover in a Broadband Wireless Access (BWA) communication system, the BWA communication system including a plurality of Mobile Subscriber Stations (MSSs), a serving Base Station (BS) for providing a communication service to the MSSs, and a plurality of sponsor nodes connected between the MSSs and the serving BS for providing the communication service to the MSSs, the method comprising the steps of:
detecting, by an MSS, a need to handover while communicating with the serving BS;
transmitting, by the MSS, a handover request to the serving BS;
receiving, by the serving BS, the handover request from the MSS;
selecting, by the serving BS, one of the plurality of sponsor nodes as a target sponsor node to which the MSS will handover; and
notifying the MSS that the MSS shall perform the handover to the target sponsor node.

2. The method as claimed in claim 1, wherein the BWA communication system utilizes a mesh mode in which communication is performed between the serving BS and the MSSs, and between the MSSs.

3. The method as claimed in claim 1, wherein the plurality of sponsor nodes include the serving BS.

4. The method as claimed in claim 1, wherein the plurality of sponsor nodes include an MSS within a service coverage of the serving BS.

5. The method as claimed in claim 1, further comprising a step of performing a network entry operation with the target sponsor node, after the MSS notifies the serving BS that the MSS will perform the handover to the target sponsor node.

6. The method as claimed in claim 1, wherein the MSS detects need to handover when a value obtained by subtracting an intensity of a signal received from the serving BS from an intensity of signals received from the plurality of sponsor nodes exceeds a preset intensity.

7. The method as claimed in claim 1, wherein the MSS transmits an identifier of a candidate sponsor node, to which the MSS will perform the handover, to the serving BS, when the MSS transmits the handover request to the serving BS.

8. The method as claimed in claim 1, wherein the step of selecting, by the serving BS, the one of the plurality of sponsor nodes as the target sponsor node to which the MSS will handover comprises the steps of:
measuring, by the serving BS, channel quality of the serving BS and calculating a data rate, when the target sponsor node to which the MSS is to be handed over is the serving BS;
determining if it is possible to meet a bandwidth required by the MSS intended for the handover by comparing data rates between the MSS and candidate target sponsor nodes; and
determining the target sponsor node based on the comparison.

9. The method as claimed in claim 1, further comprising the steps of:
calculating a data rate by the serving BS by
$$DataRate = \frac{{\sum }_{i = 1}^{n} {DR}_{MSS ( i - 1 ) - MSSi}}{n} , {MSS}_{o} = BS \qquad ( 1 )$$
when the target sponsor node to which the MSS will perform the handover is a different MSS;
determining if it is possible to meet a bandwidth required by the MSS intended for the handover by comparing data rates between the MSS and candidate target sponsor nodes each other; and
determining the target sponsor node,
wherein MSSᵢ represents the MSS intended for the handover, MSS₍ᵢ₋₁₎ represents the target sponsor node, n represents a distance between the MSSᵢ and the serving BS, and DR_{(MSSi-1)-MSSi} represents a data rate based on channel quality between the MSS₍ᵢ₋₁₎ and the MSSᵢ.

10. A method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs, the method comprising the steps of:
detecting, by the MSS, a need to handover, while performing direct communication with the serving BS;
transmitting, by the MSS, a handover request to the serving BS;
receiving, by the MSS, a notification that the MSS shall perform the handover to a target sponsor node selected from the plurality of sponsor nodes, from the serving BS, in response to the handover request; and
notifying the serving BS that the MSS will perform the handover to the target sponsor node from the serving BS.

11. The method as claimed in claim 10, further comprising the step of performing a network entry operation with the target sponsor node, after the MSS notifies the serving BS that the MSS will perform the handover to the target sponsor node.

12. The method as claimed in claim 10, wherein the MSS detects need to handover when a value obtained by subtracting an intensity of a signal received from the serving BS from an intensity of signals received from the sponsor nodes exceeds a preset intensity.

13. A method for handover of a serving Base Station (BS) in a Broadband Wireless Access (BWA) communication system, the BWA communication system including a plurality of Mobile Subscriber Stations (MSSs), the BS for providing a communication service to the MSSs, and a plurality of sponsor nodes connected between the MSSs and the serving BS for providing the communication service to the MSSs, the method comprising the steps of:
receiving, by the BS, a handover request from the MSS;
selecting one of the plurality of sponsor nodes as a target sponsor node to which the MSS will perform the handover; and
notifying the MSS that the MSS shall perform the handover to the target sponsor node from the BS.

14. The method as claimed in claim 13, further comprising the steps of:
receiving a notification that the MSS will perform the handover to the target sponsor node; and
ending a supply of a direct communication service to the MSS.

15. The method as claimed in claim 13, wherein the target sponsor node is determined considering channel quality between the plurality of sponsor nodes and corresponding BS, and channel quality between the MSS and the plurality of sponsor nodes.

16. A method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs, the method comprising the steps of:
detecting, by the MSS a need to handover while communicating with a serving sponsor node;
transmitting a handover request to the serving BS through the serving sponsor node;
receiving a notification that the MSS shall perform the handover to the serving BS through the serving sponsor node, in response to the handover request; and
notifying the serving BS through the serving sponsor node that the MSS will perform the handover to the serving BS.

17. The method as claimed in claim 16, further comprising the step of performing a network entry operation with the serving BS, after notifying the handover to the serving BS.

18. The method as claimed in claim 16, wherein the MSS detects the need to handover when a value obtained by subtracting an intensity of a signal received from the serving sponsor node from an intensity of signals received from the plurality of sponsor nodes exceeds a preset intensity.

19. A method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs, the method comprising the steps of:
receiving, by an serving sponsor node of providing communication service to the MSS, a handover request from the MSS;
notifying the serving BS of the handover request of the MSS;
receiving a notification from the serving BS that the MSS shall perform a handover to the serving BS, in response to the handover request;
notifying the MSS that the MSS shall perform the handover to the serving BS from the serving sponsor node;
receiving a notification from the MSS that the MSS will perform the handover to the serving BS from the serving sponsor node; and
notifying the serving BS that the MSS will perform the handover to the serving BS from the serving sponsor node.

20. The method as claimed in claim 19, further comprising the step of ending a supply of a communication service to the MSS, after notifying the serving BS that the MSS will perform the handover to the serving BS.

21. A method for handover of a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs, the method comprising the steps of:
detecting, by the MSS, a need to handover while communicating with a serving sponsor node;
transmitting a handover request to the serving BS through the serving sponsor node;
receiving a notification that the MSS shall perform the handover to a target sponsor node selected from neighbor sponsor nodes, from the serving BS, through the serving sponsor node, in response to the handover request; and
notifying the serving BS through the serving sponsor node that the MSS will perform the handover to the target sponsor node from the serving sponsor node.

22. The method as claimed in claim 21, further comprising the step of performing a network entry operation with the target sponsor node, after notifying the handover to the target sponsor node from the serving sponsor node.

23. The method as claimed in claim 21, wherein the MSS detects need to handover when a value obtained by subtracting an intensity of a signal received from the serving sponsor node from an intensity of signals received from the sponsor nodes exceeds a preset intensity.

24. A method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing a communication service to the MSSs, and a plurality of sponsor nodes connected between the MSSs and the serving BS for providing the communication service to the MSSs, the method comprising the steps of:
receiving, by an serving sponsor node of providing communication service to the MSS, a handover request from the MSS;
notifying the serving BS of the handover request of the MSS;
receiving a notification that the MSS shall perform a handover to a target sponsor node selected from neighbor sponsor nodes, from the serving BS, in response to the handover request;
notifying the MSS that the MSS shall perform the handover to the target sponsor node from the serving sponsor node;
receiving a notification that the MSS will perform the handover to the target sponsor node from the serving sponsor node from the MSS; and
notifying the serving BS that the MSS will perform the handover to the target sponsor node from the serving sponsor node.

25. The method as claimed in claim 24, further comprising the step of ending a supply of the communication service to the MSS, after notifying the serving BS that the MSS will perform the handover to the target sponsor node from the serving sponsor node

26. The method as claimed in claim 24, wherein the target sponsor node is determined considering channel quality between the neighbor sponsor nodes and corresponding BS, and channel quality between the MSS and the neighbor sponsor nodes.

27. A method for handover in a Broadband Wireless Access (BWA) communication system, the BWA communication system including a plurality of Mobile Subscriber Stations (MSSs), a serving Base Station (BS) for providing a communication service to the MSSs, a plurality of neighbor BSs that are different from the serving BS, and a plurality of sponsor nodes connected between the MSSs and the serving BS or between the MSSs and each of the neighbor BSs for providing the communication service to the MSSs, the method comprising the steps of:
detecting, by the MSS, a need to handover while communicating with the serving BS;
transmitting, by the MSS, a handover request to the serving BS;
selecting, by the serving BS, one of the plurality of sponsor nodes of a target BS belonging to the plurality of neighbor BSs as a target sponsor node to which the MSS will perform handover;
notifying the MSS that the MSS shall perform the handover to the target sponsor node from the serving BS; and
notifying the serving BS that the MSS will perform the handover to the target sponsor node.

28. The method as claimed in claim 27, wherein the BWA communication system utilizes a mesh mode in which communication is performed between the BS and the MSSs, and between the MSSs.

29. The method as claimed in claim 27, wherein the plurality of sponsor nodes include the plurality of neighbor BSs.

30. The method as claimed in claim 27, wherein the plurality of sponsor nodes include an MSS within a service coverage of the serving BS.

31. The method as claimed in claim 27, further comprising the step of performing a network entry operation with the target sponsor node, after the MSS notifies the serving BS of the handover to the target sponsor node.

32. The method as claimed in claim 27, wherein the MSS detects need to handover when a value obtained by subtracting an intensity of a signal received from the serving BS from an intensity of signals received from the plurality of sponsor nodes exceeds a preset intensity.

33. The method as claimed in claim 27, wherein the MSS transmits an identifier of a candidate sponsor node to which the MSS is to be handed over to the serving BS, when the MSS transmits the handover request to the serving BS.

34. The method as claimed in claim 27, further comprising the step of ending a supply of the communication service to the MSS, when the serving BS has received the notification that the MSS will perform the handover to the target sponsor node from the serving BS.

35. The method as claimed in claim 27, wherein the serving BS determines the target sponsor node in consideration of channel quality between the plurality of sponsor nodes and corresponding BSs, and channel quality between the MSS and the plurality of sponsor nodes.

36. The method as claimed in claim 27, further comprising the steps of:
notifying the target BS of the handover of the MSS, after determining the target sponsor node to which the MSS will perform the handover; and
informing the target, BS that the serving BS has received a response for a notification of the handover, after receiving the response for the notification of the handover from the target BS.

37. The method as claimed in claim 27, further comprising the steps of:
measuring, by the target BS, channel quality of the serving BS and calculating a data rate when the target sponsor node to which the MSS will perform the handover is the target BS; and
determining if it is possible to meet a bandwidth required by the MSS intended for the handover by comparing the calculated data rate with candidate target sponsor nodes, and determining the target sponsor node.

38. The method as claimed in claim 27, further comprising the steps of:
calculating a data rate by the target BS by
$$DataRate = \frac{{\sum }_{i = 1}^{n} {DR}_{MSS ( i - 1 ) - MSSi}}{n} , {MSS}_{o} = BS \qquad ( 1 )$$
when the target sponsor node to which the MSS will perform the handover is a different MSS; and
determining if it is possible to meet a bandwidth required by the MSS intended for the handover by comparing the calculated data rate with candidate target sponsor nodes, and determining the target sponsor node,
wherein MSS represents the MSS intended for the handover, MSS₍ᵢ₋₁₎ represents the target sponsor node, n represents a distance between the MSSᵢ and the target BS, and DR_{(MSSi-1)-MSSi} represents a data rate based on channel quality between the MSS₍ᵢ₋₁₎ and the MSSᵢ.

39. A method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
detecting, by the MSS, a need to handover while performing direct communication with the serving BS;
transmitting a handover request to the serving BS;
receiving a notification that the MSS shall perform the handover to a target sponsor node selected from the plurality of sponsor nodes of a target BS belonging to the neighbor BSs; and
notifying the serving BS that the MSS will perform the handover to the target sponsor node from the serving BS.

40. The method as claimed in claim 39, further comprising the step of performing a network entry operation with the target sponsor node, after notifying that the MSS will perform the handover to the target sponsor node from the serving BS.

41. The method as claimed in claim 39, wherein the MSS detects need to handover when a value obtained by subtracting an intensity of a signal received from the serving BS from an intensity of signals received from the plurality of sponsor nodes exceeds a preset intensity.

42. A method for handover of a serving Base Station (BS) in a Broadband Wireless Access (BWA) communication system, the BWA communication system including a plurality of Mobile Subscriber Stations (MSSs), the serving BS for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
receiving, by the serving BS, a handover request from an MSS;
selecting one of the plurality of sponsor nodes of a target BS belonging to the neighbor BSs as a target sponsor node to which the MSS will perform handover; and
notifying the MSS that the MSS shall perform the handover to the target sponsor node from the serving BS.

43. The method as claimed in claim 42, further comprising the step of ending a supply of a direct communication service to the MSS when the serving BS is notified from the MSS that the MSS will perform the handover to the target sponsor node from the serving BS.

44. The method as claimed in claim 42, wherein the target sponsor node is determined considering channel quality between the plurality of sponsor nodes and corresponding neighbor BS, and channel quality between the MSS and the plurality of sponsor nodes.

45. The method as claimed in claim 42, further comprising the steps of:
notifying the target BS of handover of the MSS, after determining the target sponsor node to which the MSS will perform the handover; and
informing the target BS that the serving BS has received a response for a notification of the handover, after receiving the response for the notification of the handover from the target BS.

46. A method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
detecting, by the MSS, a need to handover while communicating with a serving sponsor node;
transmitting a handover request to the serving BS through the serving sponsor node;
receiving a notification that the MSS shall perform the handover to a target BS selected from the plurality of neighbor BSs, from the serving BS through the serving sponsor node in response to the handover request; and
notifying the serving BS through the serving sponsor node that the MSS will perform the handover to the target BS from the serving sponsor node.

47. The method as claimed in claim 46, further comprising the step of performing a network entry operation with the target BS, after notifying that the MSS perform the handover to the target sponsor node from the serving sponsor node.

48. The method as claimed in claim 46, wherein the MSS detects need to handover when a value obtained by subtracting an intensity of a signal received from the serving sponsor node from an intensity of signals received from the plurality of sponsor nodes exceeds a preset intensity.

49. A method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing the communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
receiving, by an serving sponsor node of providing communication service to the MSS, a handover request from the MSS;
notifying the serving BS of the handover request of the MSS;
receiving a notification that the MSS shall perform handover to a target BS selected from the neighbor BSs, from the serving BS, in response to a notification of the handover request; and
notifying the MSS of the handover to the target BS from the serving sponsor node.

50. The method as claimed in claim 49, further comprising the step of ending a supply of the communication service to the MSS, after notifying the handover to the target BS from the serving sponsor node.

51. The method as claimed in claim 49, wherein the target BS is a BS determined considering channel quality between the MSS and the plurality of neighbor BSs.

52. A method for handover of a Mobile Subscriber Station (MSS) in a Broadband Wireless Access (BWA) communication system, the BWA communication system including a plurality of MSSs, a serving Base Station (BS) for providing a communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
detecting, by the MSS, a need to handover while communicating with a serving sponsor node;
transmitting a handover request to the serving BS through the serving sponsor node;
receiving a notification that the MSS shall perform the handover to a target sponsor node selected from the plurality of neighbor sponsor nodes of a target BS belonging to the neighbor BSs, from the serving BS through the serving sponsor node, in response to the handover request; and
notifying the serving BS through the serving sponsor node that the MSS will perform the handover to the target sponsor node from the serving sponsor node.

53. The method as claimed in claim 52, further comprising the step of performing a network entry operation with the target BS, after notifying that the MSS will perform the handover to the target sponsor node from the serving sponsor node.

54. The method as claimed in claim 52, wherein the MSS detects need to handover when a value obtained by subtracting an intensity of a signal received from the serving sponsor node from an intensity of signals received from the plurality of neighbor BSs exceeds a preset intensity.

55. A method for handover of a serving sponsor node providing a communication service to a Mobile Subscriber Station (MSS) in a Broadband Wireless Access (BWA) communication system, the BWA communication system including a plurality of MSSs, a serving Base Station (BS) for providing the communication service to the MSSs, a plurality of neighbor BSs different from the serving BS, and a plurality of sponsor nodes connected between the MSSs and the serving BS or between the MSSs and each of the neighbor BSs for providing the communication service to the MSSs, the method comprising the steps of:
receiving, by an serving sponsor node of providing communication service to the MSS, a handover request from the MSS;
notifying the serving BS of the handover request of the MSS;
receiving a notification that the MSS shall perform handover to a target sponsor node selected from the plurality of sponsor nodes of a target BS belonging to the neighbor BSs, from the serving BS, in response to a notification of the handover request; and
notifying the MSS of the handover to the target sponsor node from the serving sponsor node.

56. The method as claimed in claim 55, further comprising the step of ending a supply of the communication service to the MSS, after notifying the handover to the target sponsor node from the serving sponsor node.

57. The method as claimed in claim 55, wherein the target sponsor node is a sponsor node determined considering channel quality between the plurality of sponsor nodes and corresponding BSs, and channel quality between the MSS and the plurality of sponsor nodes.
